(19) United States
(12) Patent Application Publication
(10) Pub. No.: US 2026/0017110 A1
(43) Pub. Date: Jan. 15, 2026

(54) MANAGING GPU RESOURCES ON A CONTAINER ORCHESTRATION PLATFORM

(71) Applicant: Avesha, Inc., Chelmsford, MA (US)

(72) Inventors: Raj Nair, Lexington, MA (US); Prabhudev Navali, Westford, MA (US); Eric Peterson, Carlisle, MA (US); Chin-Cheng Wu, Carlisle, MA (US)

(21) Appl. No.: 19/268,001

(22) Filed: Jul. 14, 2025

Related U.S. Application Data
(60) Provisional application No. 63/670,262, filed on Jul. 12, 2024.

(51) Int. Cl. G06F 9/50

(52) U.S. Cl. CPC G06F 9/5038; G06F 9/5022; G06F 9/5044

(57) ABSTRACT

A technique manages computing resources on a container orchestration platform. Such a technique involves establishing a pool of computing resources on the container orchestration platform. Such a technique further involves, after the pool of computing resources is established, receiving graphics processing unit (GPU) provisioning requests (GPRs) which identify workspaces. Such a technique further involves allocating computing resources from the pool to the workspaces identified by the GPRs based on a set of GPR prioritization policies.

### CROSS REFERENCE TO RELATED APPLICATIONS

This application is a regular utility application based on earlier-filed U.S. Application No. 63/670,262 filed on Jul. 12, 2024, entitled “EFFECTIVE RESOURCE MANAGEMENT OF GPUS ACROSS KUBERNETES CLUSTERS”, the contents and teachings of which are hereby incorporated by reference in their entirety.

### TECHNICAL FIELD

The present invention relates to distributed computing resource management, and more specifically to systems and methods for dynamically allocating, provisioning, scaling, etc. graphics processing unit (GPU) resources across one or more clusters in hybrid cloud, edge, and/or data center environments.

### BACKGROUND

A conventional data center includes high-performance servers running specialized software to form a container orchestration platform. Along these lines, the servers May include high-end computerized resources such as graphics processing units (GPUs), central processing units (CPUs), memory, networking hardware, etc. Additionally, the servers may run specialized software such as Amazon ECS, Azure Container Instances, Docker Swarm, Kubernetes, Slurm, etc.

Typically, these GPU resources need to be shared across various users-like teams, individual users, user-groups, programs, pipelines—for deploying their containerized application to use GPU resources. Contemporary GPU management solutions operate with static resource allocation models, cluster-centric designs that lack native multi-cluster federation capabilities, and monolithic resource management approaches that provide insufficient abstraction between physical hardware and logical resource pools. These systems typically require manual configuration for advanced features such as RDMA (Remote Direct Memory Access) networking, GPU partitioning, and cross-cluster resource sharing.

During operation, a user may deploy and run a containerized application on the platform to perform a larger-scale job or undertaking. Upon completion, the same user or another user may deploy and run another containerized application to perform another large-scale job or undertaking.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a computing environment that manages graphics processing unit (GPU) resources on a container orchestration platform in accordance with certain embodiments.

FIG. 2 is a flowchart of a procedure for managing GPU resources on a container orchestration platform in accordance with certain embodiments.

FIG. 3 is block diagram of a client device of the computing environment in accordance with certain embodiments.

FIG. 4 is block diagram of a controller of the computing environment in accordance with certain embodiments.

FIG. 5 is block diagram of a cluster of GPU nodes of the computing environment in accordance with certain embodiments.

FIG. 6 is block diagram of a first example multi-cluster configuration for the container orchestration platform in accordance with certain embodiments.

FIG. 7 is block diagram of a second example multi-cluster configuration for the container orchestration platform in accordance with certain embodiments.

FIG. 8 is block diagram of an example single cluster configuration for the container orchestration platform in accordance with certain embodiments.

FIG. 9 is a GPU resource allocation flow diagram in accordance with certain embodiments.

FIGS. 10 through 12 are block diagrams showing processing of GPU provisioning requests (GPRs) in accordance with certain embodiments.

### DETAILED DESCRIPTION

### Overview

Unfortunately, due to static allocation of GPU resources to teams or users or user groups or projects or pipelines or programs, a large portion of the computerized resources of the above-described conventional data center may sit idle at times, particularly between jobs, or may be inefficiently utilized if important jobs are required to wait while less important jobs are allowed to run to completion. For example, some large-scale jobs which utilize GPUs may not require use of all of the GPUs thus leaving GPU resources underutilized or sometimes even completely idle. As another example, while some GPUs are currently in use to perform a large-scale job, there may not be enough unused GPUs to run a more important large-scale job thus requiring the more important large-scale job to be put on hold until the less important job is finished, and so on. What is needed, therefore, is a more effective way to coordinate use of computerized resources particularly those which involve GPUs.

The above need is addressed at least in part by techniques which manage resources on a container orchestration platform. Such techniques involve establishing a pool of computing resources and then allocating computing resources from the pool to workspaces identified by GPU provisioning requests (GPRs) based on a set of GPR prioritization policies (e.g., a max-min fairness policy, an assigned priority policy, a greedy policy, a first-in-first-out policy, combinations thereof, etc.). Such techniques enable effective and efficient allocation of computing resources to the workspaces, preemptions, optimizations, combinations thereof, and so on. Additionally, such techniques enable the pool of computing resources to be formed from one or more clusters of GPU nodes (e.g., each GPU node including CPU resources, GPU resources, memory, etc.) in which clusters may be co-located and/or separated by large distances. Accordingly, such techniques provide the ability to provision the workspaces with computing resources efficiently, to minimize idle time, to scale as needed, and so on.

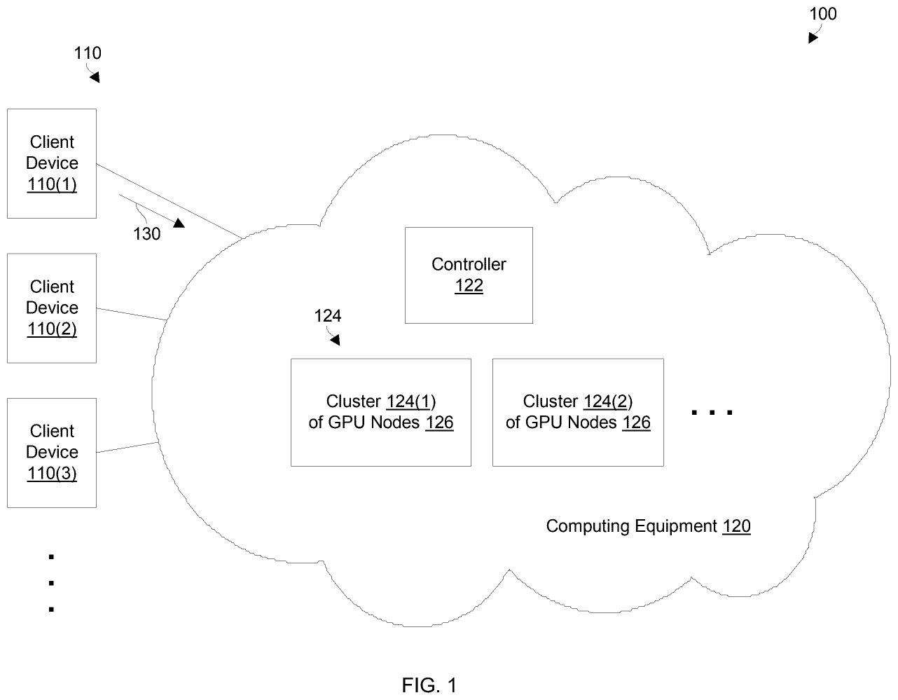

FIG. 1 shows a computing environment 100 that manages computing resources on a container orchestration platform in accordance with certain embodiments. The computing environment 100 includes client devices 110(1), 110(2), 110(3), . . . . (collectively, client devices 110) and computing equipment 120.

One or more of the client devices 110 may couple indirectly with the computing equipment 120, e.g., via computer network. Alternatively or additionally, one or more of the client devices 110 may couple with the computing equipment 120 directly or even reside within the computing equipment 120.

The client devices 110 are constructed and arranged to provide input 130 to the computing equipment 120 to perform useful work. Along these lines, the client devices 110 may be operated by respective independent operators to configure and operate the computing equipment 120 as a container orchestration platform, to create and/or process GPU provisioning requests (GPRs) on the container orchestration platform, scale/expand the container orchestration platform, and so on.

The computing equipment 120 includes a controller 122 and one or more clusters 124(1), 124(2), . . . (collectively, clusters 124) of GPU nodes 126. Although further details of GPU nodes 126 will be provided shortly, it should be understood that a cluster 124 includes a set of (one or more) GPU nodes 126. Additionally, the GPU nodes 126 include various computerized resources such as GPUs, CPUs, memory, networking interfaces, etc.

It should be understood that there is no requirement that the clusters 124 be identical. For example, the cluster 124(1) may include four GPU nodes 126 in which each GPU node 126 includes two CPUs and four GPUs. Additionally, the cluster 124(2) may include eight GPU nodes 126 in which each GPU node 126 includes two CPUs and eight GPUs, etc. Moreover, one cluster 124 may include a first type of GPU while a second cluster 124 includes a second type of GPU that is different (e.g., faster, a later generation, from a different manufacturer/supplier, etc.), and so on. Along these lines, one type of GPU may be from a first vendor and another type of GPU may be from a second vendor (e.g., Nvidia, AMD, Intel, etc) and so on.

Initially, the computing equipment 120 receives input which configures the computing equipment 120 to operate as a container orchestration platform. Along these lines, the computing equipment 120 establishes a pool of computing resources from one or more clusters 124.

Then, the computing equipment 120 processes GPRs which identify or define slice workspaces (or simply workspaces) to perform useful work. Along these lines, the controller 122 allocates computing resources from the pool to the workspaces to satisfy the GPRs and achieve various tasks. As will be explained in further detail shortly, the controller 122 performs such allocation based on a set of GPR prioritization policies. It should be understood that multiple GPRs may request provisioning for the same workspace.

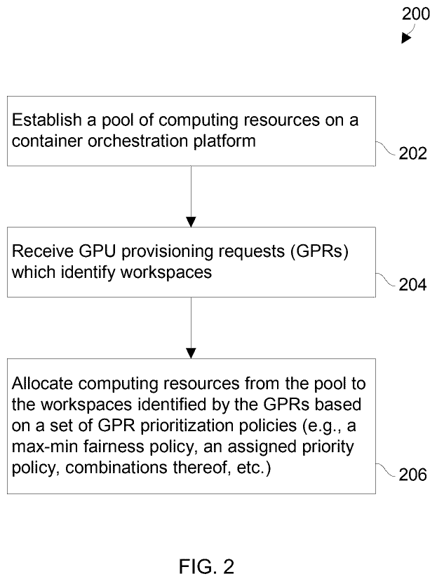

In accordance with certain embodiments, workspaces (or slices) specify various requirements to perform jobs or tasks (e.g., definitions, namespaces, amounts of resources, etc.). Once an empty workspace is provisioned with computing resources, this provisioned workspace may be considered an application overlay or grouping of application pods (or containers) and/or similar resources. Such a workspace may extend over multiple clusters that are deployed in one or more public/private clouds and/or data centers/edges. Workspaces which are similar to those used and described herein, and which are suitable for use in certain contexts described herein, are disclosed in U.S. Pat. No. 11,736,559, issued on Aug. 22, 2023, and entitled “PROVIDING A SET OF APPLICATION SLICES WITHIN AN APPLICATION ENVIRONMENT”, the contents and teachings of which are hereby incorporated by reference in their entirety. Further details will now be provided with reference to FIG. 2.

FIG. 2 shows a procedure 200 for managing computing resources on a container orchestration platform in accordance with certain embodiments. Such a procedure 200 may be performed by specialized circuitry (e.g., see the controller 122 of the computing equipment 120 of FIG. 1).

At 202, the specialized circuitry establishes a pool of GPU resources. Along these lines, the specialized circuitry may add one or more clusters of GPU nodes to the container orchestration platform and contribute the computing resources available on the one or more clusters to the pool.

At 204, the specialized circuitry receives GPRs which identify workspaces. Such GPRs may originate, or be created based on input, from one or more client devices. The workspaces identified by the GPRs may be initially empty, may have some initial provisioning from an earlier serviced GPR, etc.

At 206, the specialized circuitry allocates computing resources from the pool to the workspaces based on a set of GPR prioritization policies. Along these lines, the specialized circuitry may apply a max-min fairness policy which provisions more computing resources (e.g., reclaimed from an overprovisioned workspace) to a less provisioned workspace. As another example, the specialized circuitry may allocate computing resources to workspaces based on assigned priorities, e.g., where a workspace assigned a higher priority is provisioned ahead of a workspace assigned a lower priority, etc.

In some embodiments, a workspace (which may also be referred to as a slice) represents a foundational architectural element within the infrastructure, meticulously engineered to establish a dedicated, isolated, and highly flexible workspace. This workspace is specifically designed to accommodate the diverse operational needs of individual users and collaborative teams alike. At its core, the workspace can be conceptualized as a specialized Virtual Private Cloud (VPC) that transcends traditional limitations by possessing the unique capability to seamlessly span across one or even multiple clusters. This innovative cross-cluster spanning design is a cornerstone of its remarkable flexibility, enabling unparalleled scalability in the allocation and management of computational resources. This unified approach to resource management across disparate cluster environments simplifies complex deployments and optimizes resource utilization, thereby enhancing overall system efficiency.

Integral to the functionality of each workspace is its intricate association with one or more namespaces (e.g., project definitions and/or requirements, Kubernetes namespaces, other types of resource groupings, combinations thereof, etc.). These namespaces serve as logically isolated deployment zones, providing a structured and secure environment where users can efficiently launch, monitor, and manage a diverse spectrum of workloads. While particularly optimized for AI workloads, the robust and versatile nature of the workspace (which may also be referred to as a slice workspace) extends its utility significantly beyond AI-specific tasks. It permits the seamless deployment of non-AI workloads, including those that are predominantly CPU-bound, ensuring continuous operational capacity and support for a wide array of computational requirements at any given time. This versatility allows organizations to consolidate their varied computational needs within a unified, high-performance infrastructure.

However, a critical distinction and imperative requirement apply specifically to AI workloads that necessitate the utilization of GPUs for their execution. For such computationally intensive and demanding workloads, it is absolutely essential that GPU nodes are explicitly and proactively provisioned within the respective workspace. Without this crucial and explicit provisioning, AI workloads—for example, encapsulated as Pods or other analogous computational units within the Kubernetes ecosystem or as containerized workloads in other orchestration platforms-will inevitably enter and remain in a ‘pending’ state. In this ‘pending’ state, these workloads will indefinitely await the availability of the required GPU resources, effectively halting their execution and preventing any meaningful progress. Therefore, to guarantee the successful, timely, and efficient deployment and execution of GPU-accelerated AI workloads, users are mandated to initiate specific GPU requests. These requests are not merely declarations of intent; they actively trigger an automated provisioning process. This process orchestrates the seamless integration of dedicated GPU nodes directly into their designated Slice VPC, thereby providing the essential computational power, accelerated processing capabilities, and specialized hardware resources indispensable for their advanced AI initiatives, including machine learning training, deep learning inference, and complex data analytics. This automated provisioning ensures that the necessary computational infrastructure is dynamically scaled and made available precisely when and where it is needed, optimizing both performance and resource utilization for cutting-edge AI developments.

Such workspaces may be associated with one or more namespaces and a user.

It should be understood that Kubernetes may be occasionally mentioned in this document (e.g., below) for illustration purposes. However, Kubernetes is referred to by way of example only and any other container orchestration mechanisms may be used instead of or in addition to Kubernetes.

Users or Admins can create a slice workspace for a training/fine tuning/inference or any other Job that requires GPU resources, a job group, a project, or a user (or User group) to deploy and develop applications in the namespaces. Once a slice workspace is created, a user can request GPUs for the workspace using Create GPR (GPU provision requests) to get GPUs allocated for the workspace.

### Client Device Details

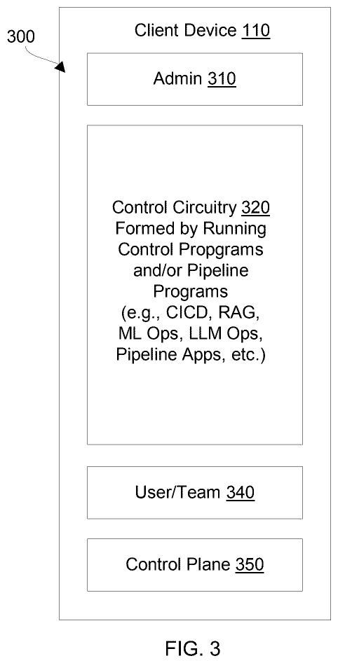

With reference to FIG. 3, a client device 110 is constructed and arranged to provide input 130 to the controller 122 of the computing environment 120. Along these lines, such a client device 110 may include one or more of a variety of circuits or user interfaces or APIs (Application Program Interface) or SDK based programs (software development kit) 300 such as admin user 310, control circuitry 320, user/user-group/team circuitry 340, and control plane circuitry 350. The example client device 110 of FIG. 3 includes all of the variety of circuits 300 for illustration purposes only. In some arrangements, the circuits 300 are formed by processing circuitry (e.g., a processor chipset) executing specialized code.

The admin circuitry 310 is constructed and arranged to perform various operations such as cluster registration and management, slice workspace creation and role based access control (RBAC) setup, GPU inventory and queue management, and priority adjustments and approvals. In some arrangements, the admin circuitry 310 requires operator privileges which are superior to user privileges.

The control circuitry 320 refers to specialized circuitry formed by running control programs and/or pipeline programs, and is constructed and arranged to manage the life-cycle of the GPRs and other resources managed by the system.

The user/team circuitry 340 is constructed and arranged to provide self-service GPU provisioning requests, real-time visibility into wait times, workload and GPU observability, and API-driven automation support.

The control plane circuitry 350 is constructed and arranged to enable the client device 110 to generally form part of the control plane of the computing environment 100.

### Controller Details

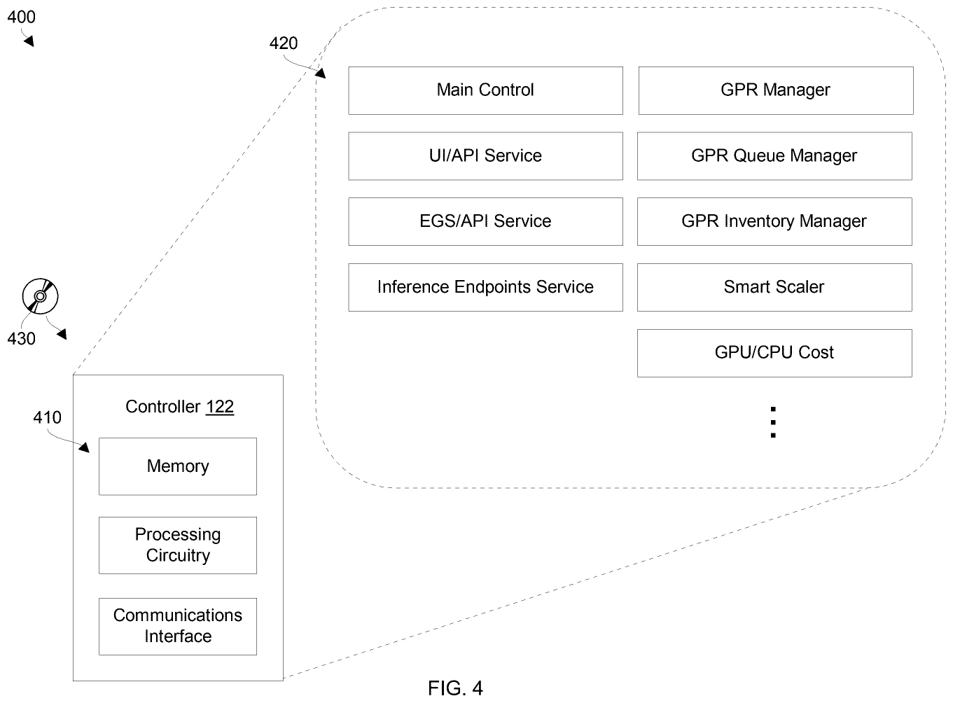

FIG. 4 shows a view 400 regarding certain details of the controller 122. As shown, the controller 122 is formed by various components 410 such as memory, processing circuitry and a communications interface, among other things (e.g., power supplies, fans, cabling, etc.). Along these lines, the processing circuitry operates in accordance with certain software constructs stored in the memory (e.g., an operating system, control code, etc.) to form specialized circuitry that enables the controller 122 perform various operations (or provide various services) 420 such as manage GPU resources on a container orchestration platform. The processing circuitry may be implemented in a variety of ways such as via one or more processors (or processing cores) running specialized software, field programmable gate arrays (FPGAs), application specific ICs (ASICs) and associated programs, discrete components, analog circuits, other hardware circuitry, combinations thereof, and so on. In some arrangements, at least a portion of the controller 122 may reside within or leverage the resources of one or more clusters 124.

In the context of one or more processors or the like executing locally stored software, a computer program product 430 is capable of delivering all or portions of the software to the controller 122. For example, the computer program product 430 may include a non-transitory computer readable medium which stores a set of instructions that controls one or more operations of the controller 122. Examples of such computer readable storage media include tangible articles of manufacture and apparatus which store instructions in a non-volatile manner such as DVD, CD-ROM, flash memory, disk memory, tape memory, and the like.

As shown in FIG. 4, the specialized circuitry within the controller 122 includes main control circuitry which performs main control operations and/or provides main control services. Along these lines, the main control circuitry serves as the central orchestration engine for cluster management.

For example, in the context of a multi-cluster configuration, the main control circuitry is able to provide full multi-cluster management. Along these lines, the main control circuitry manages cluster communications by facilitating secure communication between slice operators (e.g., local cluster control agents) deployed on different clusters, ensuring consistent state across the infrastructure. Additionally, the main control circuitry provides role-based access control (RBAC) management by reconciling RBAC policies across clusters, maintaining security boundaries between slices and users. Furthermore, the main control circuitry provides APIs by exposing APIs for workspace creation, slice management, and administrative operations through an EGS UI (elastic GPU service user interface). Also, the main control circuitry provides state synchronization by maintaining eventual consistency of slice configurations across all registered clusters

As further shown in FIG. 4, the specialized circuitry within the controller 122 includes EGS/API service circuitry which provides an API Gateway that acts as the primary backend interface for all GPU resource management operations. Certain details for particular embodiments regarding the controller 122 are described below.

### Controller Services

### KubeSlice Controller

The KubeSlice Controller serves as the central orchestration engine for multi-cluster management. It facilitates secure communication between Slice Operators and aiOps Operators deployed on different clusters, ensuring consistent state across the infrastructure. It also reconciles role-based access control policies across clusters, maintaining security boundaries between slices and users. Furthermore, it exposes APIs for workspace creation, slice management, and administrative operations through the EGS UI, and maintains eventual consistency of slice configurations across all registered clusters.

### EGS API Service

The API Gateway acts as the primary backend interface for all GPU resource management operations: The Inventory API provides real-time access to GPU resource availability, allocation status, and capacity planning data. The Workspace API manages user environments, organizational structures, and slice configurations. The GPR API handles the full lifecycle of GPU Provisioning Requests including creation, modification, priority adjustment, and deletion. Finally, Integration Points refers to RESTful APIs for third-party platform integration and automation workflows.

### GPR Manager

The GPR Manager orchestrates the complete lifecycle of GPU Provisioning Requests, including Request Processing: validating incoming GPRs against policies, quotas, and available inventory; Inventory Coordination: interfacing with Inventory Manager APIs to allocate and deallocate GPU resources; Queue Management: submitting requests to Queue Manager with appropriate priority and scheduling parameters; Status Tracking: continuously updating GPR status (Pending, Provisioning, Active, Exiting) and managing state transitions; and Eviction Handling: managing resource preemption for high-priority requests by coordinating lower-priority evictions.

### Queue Manager

The Queue Manager implements sophisticated scheduling algorithms for GPU request processing. It uses a max-heap based priority queue with efficient O(log n) operations. Fair scheduling algorithms are implemented to prevent starvation while respecting priorities. Queue operations include inserting new requests with priority assignment, extracting highest priority requests for processing, dynamic priority adjustment by administrators, and batch operations for queue reorganization. Multi-factor scheduling considers GPU count, exit duration, and submission time for requests with equal priority. An API interface exposes queue state and operations to other components.

### Inventory Manager

The Inventory Manager maintains comprehensive real-time visibility of GPU resources. This includes Resource Tracking, which monitors GPU nodes, devices, and their attributes across all registered clusters, and Allocation Management, which tracks current allocations, reservations, and available capacity. It also involves Schedule Maintenance, which maintains detailed schedules showing when resources will become available. The Inventory Manager provides Inventory APIs for real-time capacity queries by cluster, GPU type, or slice, allocation and deallocation operations, historical utilization data, and predictive availability based on current schedules. Finally, it uses Database Integration to persist inventory state with support for complex queries and reporting.

### Wait-Time Service

The Wait-time Service provides intelligent predictions for resource availability. The Prediction Algorithm calculates estimated wait times based on current inventory, active workloads, and queued requests. Multi-Factor Analysis considers GPU type requirements, network needs, priority levels, and historical patterns. Real-time Updates continuously refine predictions as system state changes. The API Interface provides wait-time estimates for different GPU configurations and cluster options.

### Smart Scaler

Smart scaler provides RL-based predictive auto-scaling support for all the LLM and other AI/ML based inference endpoints/services deployed in the workspaces across one or more clusters. The inference endpoints can be deployed within a scope of a single cluster or across multiple clusters. Smart Scaler provides interfaces and functions to predict the number of pods or deployments required based on the current conditions. It uses the real-time metrics-GPU metrics and LLM/ML framework metrics—to predict the request per seconds (RPS) and other key LLM/ML attributes and uses it to predict the number of pods (or instances) to handle the current load on the inference services.

### Inference Endpoints Service

Inference endpoints service enables Clients (user/user-group/pipelines/programs-using UI/SDK/APIs) to create and manage the life-cycle of inference endpoints and scale the endpoints-including scale to zero functionality. Inference Engines: Kserve, NIM, Dynamo (p&d), Triton, vLLM; ML Frameworks: PyTorch, TensorFlow, NIM, vLLM, TRT-LLM, TGI; Models: LLM, image, etc.

### GPU/CPU Cost Service

GPU/CPU cost service rolls-up the GPU and CPU cost across all the workspaces and GPUs (and CPUs) managed by the Elastic GPU service platform. The GPU costs are rolled-up on a per GPR or across the workspace (could be team or user or user-group or project or pipeline). The cost reports can be used for chargeback and other budgeting/billing workflows.

### Cluster Details

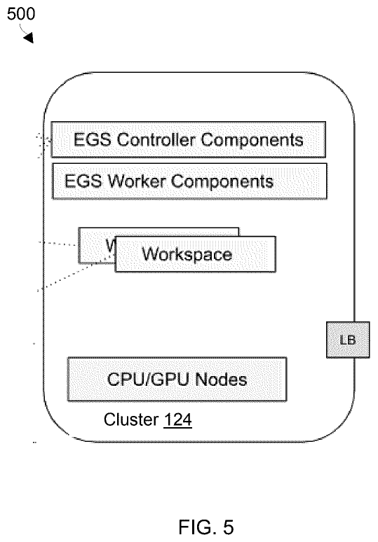

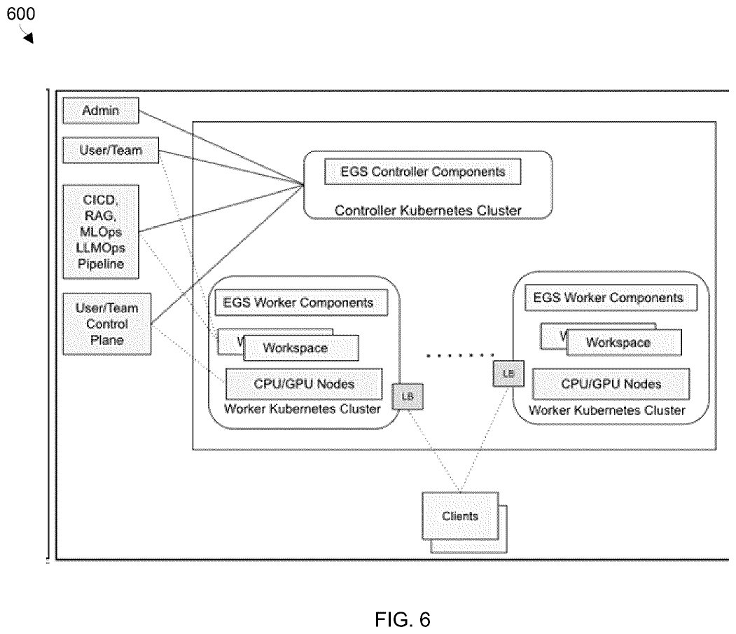

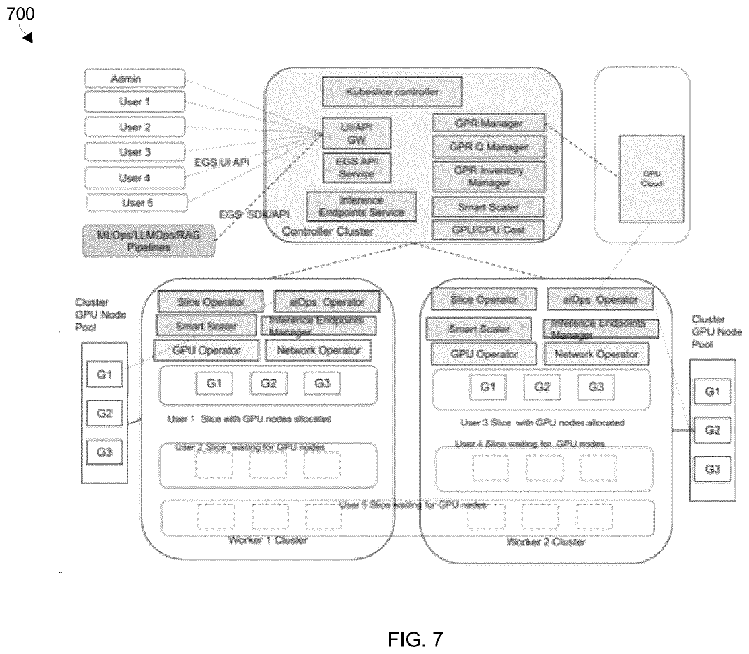

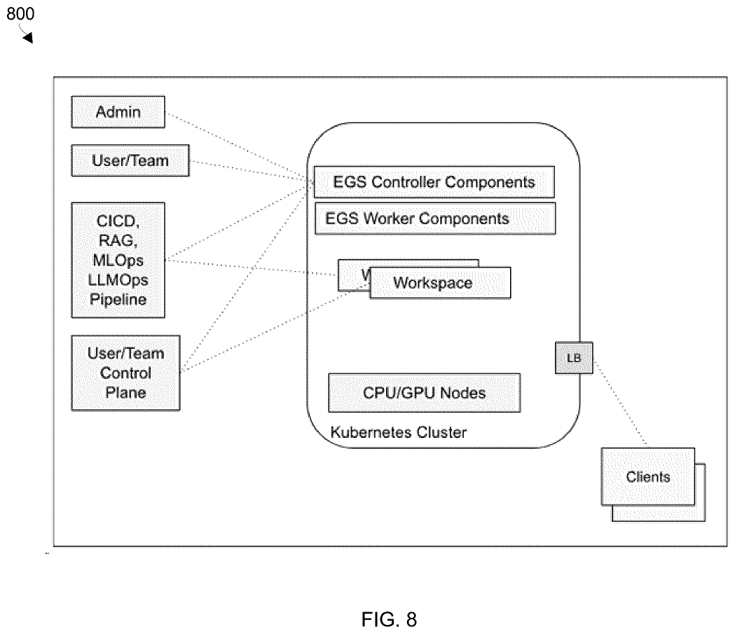

Various cluster details will now be provided with reference to FIGS. 5 through 8. FIG. 5 shows certain cluster componentry in accordance with certain embodiments. FIG. 6 shows a first example multi-cluster configuration in accordance with certain embodiments. FIG. 7 shows a second example multi-cluster configuration in accordance with certain embodiments. FIG. 8 shows an example single cluster configuration in accordance with certain embodiments.

It should be understood that other cluster configurations are suitable for use. Additionally, one cluster configuration can be transformed into another cluster configuration. Certain details for particular embodiments regarding the cluster 124 are described below.

In accordance with certain embodiments, specific features, componentry, and/or alternatives may include:

### Worker Services

### Slice Operator

The Slice Operator manages the slice abstraction on worker clusters. It handles Slice Reconciliation by synchronizing slice configurations from the controller cluster. Network Management is also a key function, configuring slice-specific networking, including overlay networks and service discovery. Additionally, the operator performs RBAC Implementation, enforcing access controls at the namespace and resource levels, and conducts Resource Usage Reporting, collecting and reporting GPU workload metrics to the controller. Finally, it is responsible for Event Generation, creating alerts and notifications for slice-level events.

aiOps Operator

The aiOps Operator handles the core GPU provisioning and management functions. These include GPU Reservation, which manages the reservation lifecycle for incoming GPRs, including node selection and labeling. Node Configuration involves applying appropriate labels for slice association, configuring node affinities and tolerations, and setting up GPU sharing modes (Multi Instance GPU (MIG), vGPU, time-slicing). Pre-provisioning Checks consist of node health verification, network connectivity testing, NCCL (Nvidia Collective Communication Library) latency validation, and GPU device functionality tests. The operator also performs Workload Management by monitoring AI workloads and enforcing resource boundaries. Inventory Reconciliation continuously updates inventory state with the controller, and Remediation Actions handle node failures, configuration drift, and automatic recovery.

### Monitoring Components

DCGM/AMD/IntelGPU metrics Integration: Collects detailed GPU metrics including temperature, power, utilization, and errors. Prometheus: Aggregates metrics from all components for time-series analysis. Grafana Dashboards: Provides visualization for users and administrators. Alert Manager: Processes alerts and routes notifications based on severity and ownership.

### Supporting Components

### EGS Agent

Handles automatic GPR creation based on workload deployment patterns, monitors namespace activity for GPU resource needs, and provides lightweight integration for existing workloads.

### Database Layer

Stores persistent state for inventory, reservations, and historical data. Supports high-availability configurations. Provides an audit trail for all allocation activities.

### Smart Scaler Agent

Collects GPU, CPU and infrastructure metrics; collects Inference or AI/ML workload deployment configuration in a workspace; collects Inference ML/LLM framework metrics. Applies inference or AI/ML workload instance scaling recommendations from the smart scaler in the controller (or control plane) to Keda/HPA or planner configuration to adjust the auto-scaling of inference or AI/ML workloads (instances, pods or collection of pods).

### Multi-Cluster Example

As mentioned above, FIGS. 6 and 7 show example multi-cluster configurations in accordance with certain embodiments. In accordance with certain embodiments, specific features, componentry, and/or alternatives may include:

### Overview

EGS architecture follows a distributed control plane model with centralized management and distributed execution. The architecture separates concerns between resource management, scheduling, and workload execution while maintaining high availability and scalability.

### Core Components Architecture

### Controller Layer

The controller layer provides centralized management and consists of the Kubernetes Controller for core orchestration and CRD management, the UI/API Gateway for RESTful APIs and user interface backend, the GPR Manager for lifecycle management of GPU provision requests, the Queue Manager for priority-based request queuing and scheduling, the Inventory Manager for real-time GPU resource tracking across clusters, the Wait-time Service for predictive analytics for resource availability, the Smart Scaler Service for predictive auto-scaling for AI/ML workloads, the Inference Endpoints Service, and the GPU/CPU cost service.

### Worker Layer

Slice Operator: Manages slice networking and namespace isolation. aiOps Operator: GPU node provisioning and lifecycle management. Smart scaler Agent: Manages the lifecycle of inference endpoints auto-scaling or any other AI/ML workload deployments auto-scaling. GPU Operator: NVIDIA/AMD/Intel GPU device plugin and driver management. Network Operator: RDMA and secondary network configuration. Monitoring Stack: Prometheus, DCGM, and metrics collection. Multi-vendor support: Nvidia CUDA, AMD RoCM, Intel Gaudi GC/HCL/HCCL APIs.

### Data Flow Architecture

1. User Request Flow: User Portal→API Gateway→GPR Manager→Queue Manager→Inventory allocation
2. Provisioning Flow: Controller→Worker Cluster→aiOps Operator→Node Configuration→Slice attachment
3. Monitoring Flow: GPU Metrics→DCGM→Prometheus→Grafana→User dashboards
4. Inventory Update Flow: Worker nodes→aiOps Operator→Inventory Manager→Database

### Multi-Cluster Architecture

For multi-cluster deployments, the architecture involves a Central Controller Cluster responsible for managing metadata and scheduling. Worker Clusters handle local state maintenance and execution of provisioning tasks. Secure Cross-Cluster Communication ensures secure data exchange between clusters. Federated Inventory Management achieves eventual consistency across the distributed inventory. Cluster-Specific Policies support the application of unique policies and constraints for individual clusters.

### High Availability Design

Controller components support active-passive failover. Distributed state management using Kubernetes etcd. Worker cluster autonomy during controller outages. Persistent queue and inventory state in external database. Automatic reconciliation after network partitions.

### Security Architecture

RBAC-based access control at slice and namespace levels; service account isolation between slices; network policies for inter-slice isolation; audit logging for all GPU allocation activities; and integration with enterprise identity providers.

EGS in a multi-cluster deployment will typically have a controller cluster where all the EGS controller related components are deployed and acts as a control plane to manage GPU/CPU and other resources in one or more worker clusters.

EGS Controller cluster (in a multi-cluster deployment) can be co-resident within a worker cluster as well.

Controller and worker clusters are kubernetes clusters.

Controller cluster manages one or more worker clusters. Worker clusters can be deployed in—on-prem, cloud provider, edge location, data center, etc. Worker cluster examples include vanilla kubernetes or openshift or rancher/etc. cluster in on-prem or data center, EKS/Openshift in AWS cloud, AKS in Azure, etc. The clusters can be constructed out of GPU/CPU nodes in data center or cloud compute instances like EC2 instances—CPU/GPU ec2 instances, GCP or OCI compute/GPU shapes nodes. The clusters can be AIPC or AI workstations—typically deployed in the edge locations.

Worker clusters are registered with the EGS control plane. Users/programs can use UI/API/SDK to register the cluster with the EGS control plane.

Worker cluster inventory management: once the worker cluster is registered, the EGS control plane in the worker cluster and controller work together to roll up the GPU/CPU inventory available in the worker cluster. These GPUs/Nodes then will be managed by the EGS. EGS will allocate and provision these nodes/GPUs for workspaces—by allocating them for GPRs (GPU provisioning requests).

EGS is vendor agnostic and supports multiple GPU vendors-like-Nvidia, AMD, ARM, Intel, etc. The worker clusters will be deployed with appropriate vendor specific drivers, plugins, GPU operators, metrics collectors and other CUDA/ROCM/etc. software components to support AI workloads/applications.

EGS controller is deployed with EGS controller components to manage the slice workspaces across the clusters. The workspaces can be scoped to a single cluster or can span across one or more clusters. EGS provides APIs/SDKs for admins/users/ML-engineers/devops engineers/programs/rag-pipelines/ml-ops pipelines/llm-ops pipelines to interact and manage the resources with the EGS control plane.

EGS provides admin and user workflows for self service management of life-cycle of workspace and GPU allocations for workspaces. In addition, it provides workflows to manage the inference endpoints and fine-tuning workflows.

Once the EGS controller is deployed Admin or user can use either UI/APIs/SDK to create and manage the workspaces.

Workspaces are typically associated with a team or a user or user group or a project or rag-pipeline or CICD pipeline or llm-ops pipeline or could be part of a control plane function for managing the life-cycle of an AI workload.

Workspace is typically associated with one or more namespaces and associated RBACs.

As mentioned above, workspace can be scoped to one cluster or one or more clusters and one or more namespaces. For a given workspace typically a slice RBAC (workspace RBAC) is associated with proper roles defined to manage the workspace. For a given workspace a kubeconfig (kubernetes workspace access configuration file with appropriate roles defined to access the namespaces associated with the workspace).

Admins/Users/programs/pipelines can get the kubeconfig from the EGS control plane (UI/API/SDK) to access and manage the workspace deployments.

Once the workspace is set up-users/programs/pipelines can request GPUs for the workspace (Slice VPC) using GPU provisioning requests. By default, the workspaces don't have any GPUs associated with them. Users/programs/pipelines request GPRs using GPR APIs. Alternatively, you can set up a GPR template and associate it with the workspace and use the template with GPR allocations.

In addition, EGS supports auto-GPR functionality where GPRs are triggered when an AI workload requesting a GPU resource is deployed in the slice workspace. The deployment and pod requests trigger auto-GPR capability and requests GPUs by creating a GPR with EGS control plane.

EGS control plane has a comprehensive GPR life-cycle management-using GPR queues, inventory management, and sophisticated allocation algorithms. The GPR queue manager manages the queues and allocates the GPUs for the GPR. Allocation takes into account a number of attributes-including priority, GPU type/memory/node type, CPU and NUMA topology, GPU memory requirements, GPU node location in the network topology and other network related attributes.

GPR manager implements sophisticated wait time calculation and updating wait times for allocation based on the real time metrics and changes in the priority, fairness, node failures and other conditions. Node remediation and other workflows affect the wait times. GPR manager continues to reconcile the queues, priorities, fairness and wait times based on the current inventory and node/GPU status and allocation state.

GPR allocation supports multiple algorithms-including priority, greedy, max-min fairness, max-min fairness with priority, etc.

Once the GPR is allocated by the EGS controller-allocation of nodes requested in the GPR EGS control plane in the worker cluster (EGS worker components in the worker cluster) provisions the GPUs (nodes) into the slice workspace. This GPU slide-in/slide-out of GPU nodes into the Slice VPC (slice workspace) is performed by the EGS worker components. The GPUs/GPU nodes are validated-health check, NCCL latency check, memory integrity check, etc. are performed before deploying the GPUs/GPU nodes into the workspace. EGS typically uses a pre-check slice to pre-provision the nodes/gpu and run tests, including some benchmarking tests to validate before inserting them into the workspace.

GPR typically has a duration—for how long the GPUs are provisioned in the workspace. Once the duration is completed the GPUs/GPU nodes are released back into the free pool. A GPR can end when it is early-released or evicted due to various reasons-preemption, priority, remediation, spot instance going away, node failure, node taken out of service etc.

Similarly, when the GPR is evicted or completed or early-released-GPUs/GPU nodes are checked for health, latency and cleanup memory or disk used by the workspace. Typically, EGS uses a cleanup slice and moves the GPR associated GPUs to the cleanup slice to perform the cleanup tasks-including cleaning up the memory, disk etc.

Once the workspace is created and GPR requested, allocated and provisioned any AI workload previously deployed or deployed after can access the GPUs/Nodes that are provisioned in the slice workspace (Slice VPC). The AI workloads can be inference, fine-tuning, training or any AI/ML workload that requires GPUs.

Once the AI workload is deployed and running users can use sophisticated observability capabilities of the EGS to get insights into the workload and GPUs associated with the workloads. They can get detailed workload/GPU performance metrics.

EGS Services Integrate with:

Kubernetes schedulers such as Run: ai and Volcano. Kueue, a cloud-native job queuing system for batch, HPC, AI/ML, and similar applications in a Kubernetes cluster. Frameworks including KubeFlow, Slurm, Slurm on Kubernetes, PyTorch, and distributed LLM training and fine-tuning frameworks. Frameworks like Spark, Flink, TensorFlow, Ray, and MLflow. EGS doesn't replace the kubernetes native or orchestration platform specific schedulers. It is an allocation and provisioning platform on top of the native schedulers.

### Single Cluster Example

As mentioned above, FIG. 8 shows an example single cluster configuration in accordance with certain embodiments.

In single cluster deployment embodiment both worker and controller components are deployed in the same single cluster. And all the client (admin, user, programs, pipelines) workflows to manage the platform workflows and resources (like workspace, GPRs, inference endpoints and smart scaler scaling workflows) within the single cluster scope.

### Further Details

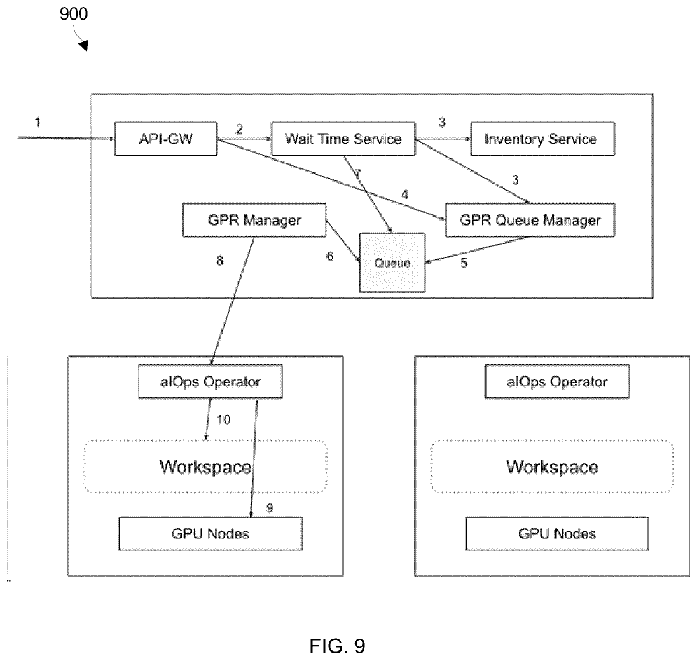

FIG. 9 shows certain details regarding GPU resource allocation to provision a set of workflows in accordance with certain embodiments. Such activity may be coordinated by various components (or services) operating within a computing equipment controller which manages one or more clusters of GPU nodes (e.g., also see the controller 122 in FIGS. 1 and 4).

At 1, a user provides input to the controller to create a GPU provisioning request (GPR). Along these lines the controller may operate as a UI (User Interface) portal, or provide access via an API (application programming interface), SDK (software development kit), etc. when creating the GPR Additionally, the controller may perform GPR validation.

At 2, an EGS (elastic GPU service) API GW (API Gateway) of the controller receives the GPR and calls a Wait Time Service of the controller to validate a wait time for the GPR.

At 3, the wait time service of the controller communicates with an inventory and queue manager to recalculate the wait time.

At 4, the EGS API GW of the controller adds the GPR to a queue via a GPR queue manager of the controller. Along these lines, the GPR queue manager may insert the GPR into a queue based on a predefined allocation algorithm and GPR configuration.

As shown at 5, the GPR queue manager periodically manages a set of queues based on the inventory service updates. Along these lines, in accordance with the allocation algorithm, the GPR queue manager periodically performs rebalancing of the queue based on the current conditions. Additionally, the GPR queue manager marks the allocation status to ready, pending based on the allocation algorithm.

At 6, a GPR manager of the controller periodically checks if any GPRs are ready for provisioning resources.

At 7, the wait time service of the controller periodically (and based on triggers) updates the GPR wait times.

At 8, the GPR manager kicks off provisioning of resources to the allocated GPR to notify the worker cluster.

At 9, in response to communication from the GPR manager, the aiOps operator in the worker cluster handles the provisioning requests and marks nodes. The aiOps operator may further adds labels to the nodes making them allocated to the workspace.

At 10, the aiOps operator associates GPU nodes with the workspace.

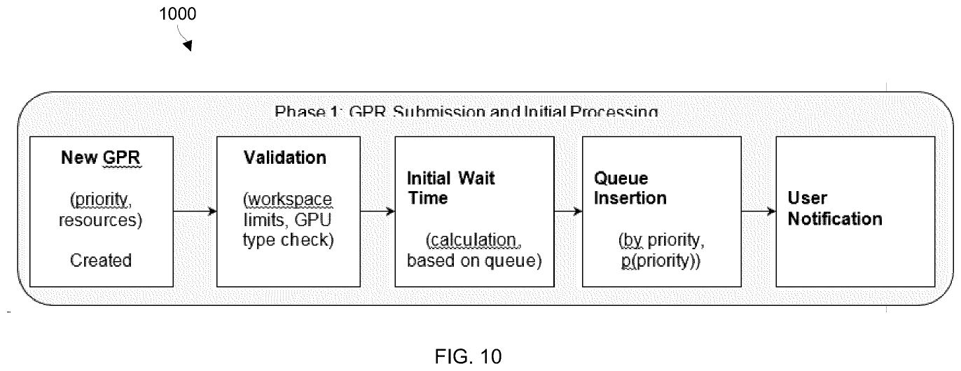

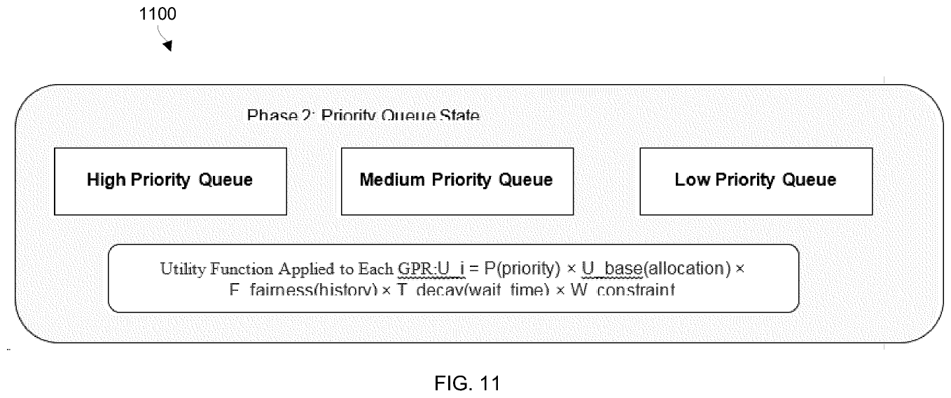

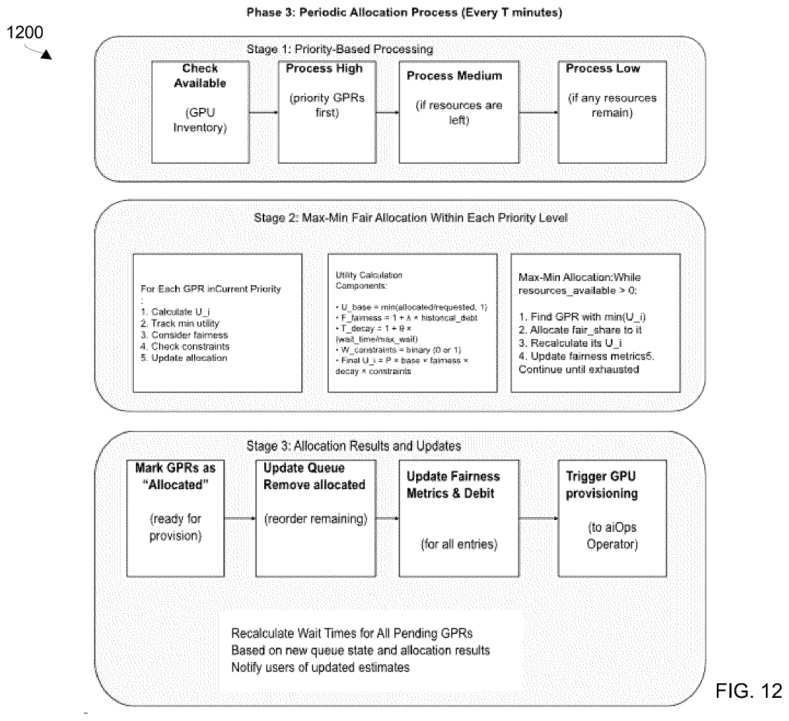

FIGS. 10 through 12 show processing of GPRs in accordance with certain embodiments. FIG. 10 shows a view 1000 of a first phase of such processing. FIG. 11 shows a view 1100 of a second phase of such processing. FIG. 12 shows a view 1200 of a third phase of such processing.

As shown in FIGS. 10 through 12, the phases involve queue management and allocation flow. In particular, the phases carry out allocation in accordance with a max-min fairness allocation algorithm.

The first phase involves GPR submission and initial processing. The second phase handles priority queue state. The third phase, which is illustrated in three stages, involves use of a periodic allocation process.

The third phase may involve priority-based processing (stage 1), max-min fair allocation within each priority level (stage 2), and allocation results and updates (stage 3). In connection with stage 3, wait times for all pending GPRs may be recalculated based on new queue state and allocation results with users being notified of updated estimates.

In some embodiments, this is a continuous process loop that repeats periodically (e.g., every T minutes where T is a positive integer), constantly adapting to new GPRs, changing inventory, and evolving fairness metrics to ensure both priority-based service and fairness within each priority tier.

At this point, it should be appreciated that the rapid proliferation of artificial intelligence and machine learning workloads has driven unprecedented demand for Graphics Processing Unit (GPU) resources across diverse computing environments, including traditional data centers, public cloud platforms, hybrid infrastructures, and edge computing deployments. Modern GPU workload deployment typically relies on container orchestration platforms, particularly Kubernetes, which provides the foundational infrastructure for managing distributed AI/ML applications. Current implementations utilize GPU device plugins and resource management frameworks that enable basic GPU allocation and scheduling capabilities across cluster nodes. These systems support various GPU architectures from leading manufacturers (NVIDIA, AMD, Intel) and can accommodate different deployment models, from bare-metal configurations to virtualized environments with GPU passthrough or partitioning technologies such as Multi-Instance GPU (MIG).

However, the existing state of the art in GPU resource management reveals significant architectural limitations that constrain the efficiency and scalability of AI/ML workloads. Contemporary Kubernetes-based GPU management solutions operate with static resource allocation models, cluster-centric designs that lack native multi-cluster federation capabilities, and monolithic resource management approaches that provide insufficient abstraction between physical hardware and logical resource pools. These systems typically require manual configuration for advanced features such as RDMA networking, GPU partitioning, and cross-cluster resource sharing. Furthermore, current observability frameworks lack GPU-aware monitoring capabilities that can correlate infrastructure metrics with model performance, workload characteristics, and business objectives, resulting in limited visibility into resource utilization patterns and optimization opportunities.

The complexity of managing heterogeneous GPU infrastructure across different deployment environments has led to the development of various vendor-specific and open-source tools that address specific aspects of GPU workload management, yet no comprehensive solution exists that unifies resource allocation, monitoring, and optimization across the full spectrum of deployment scenarios. Existing approaches remain fragmented, requiring manual integration and custom tooling to bridge gaps between resource scheduling, performance monitoring, and capacity planning functions, thereby creating operational overhead and limiting the ability to achieve optimal resource utilization in production AI/ML environments.

As one core problem area, there are critical observability gaps. Along these lines, developers lack unified visibility into GPU resource requests and workload performance, making it hard to optimize. Administrators struggle with multi-tenant resource management, hierarchical drill-down, and request lifecycle management, leading to inefficient enforcement of quotas and slow troubleshooting.

As another core problem area, there are resource management inefficiencies. This includes constrained resource scheduling due to a lack of abstraction layers, static cluster boundaries, and inflexible time-sharing. Dynamic provisioning is hampered by manual pool management, configuration rigidity (e.g., reconfiguring for MIG), and poor utilization optimization. Network configuration for RDMA is also largely manual, and inventory/health management systems are static, leading to configuration drift. Capacity planning is blind due to a lack of trend analysis and predictive provisioning.

These problems result in a significant quantified business impact. For example, from a financial perspective, there may be $2-5 M annually in resource underutilization costs for medium-sized AI teams, 3-5 FTEs dedicated to manual GPU management, 20-30% job failure rates, and 40% longer development cycles. From an operational perspective, there may be 60% of administrator time spent on manual tasks, 25% developer productivity loss, 4-6 hour MTTR for resource issues, and 15-20% SLA violations. Furthermore, there may be a competitive disadvantage with delayed model training, throttled innovation, and talent retention issues.

The root causes may be attributed to architectural limitations such as monolithic resource management, static configuration models, cluster-centric design, and missing abstraction layers. As another root cause, there may be technology gaps due to the lack of GPU-aware monitoring, automation frameworks, integrated tools, and an intelligence layer for optimization. Additionally, there may be process deficiencies such as reactive management, manual workflows, siloed operations, and no feedback loops from historical data.

In summary, the current state of GPU resource management is a critical bottleneck for AI/ML innovation, leading to substantial waste, delays, and frustration, necessitating a comprehensive solution to maintain competitive advantage.

The escalating demand for GPU resources, driven by the rapid expansion of AI/ML workloads, highlights severe limitations in current Kubernetes-based GPU management solutions. These shortcomings span critical areas: observability, resource management, and automation. The direct consequences are alarming: GPU resources, which are a significant capital investment, are severely underutilized (typically 30-40%), operational overhead soars, and organizations struggle to meet the dynamic needs of their AI/ML initiatives.

Moreover, it should be appreciated that there may be developer experience challenges. Currently, developers face a fragmented and opaque environment, lacking a unified view of GPU resource requests and workload performance. There's no integrated correlation between model parameters, GPU metrics, and job performance, forcing reliance on multiple, disconnected tools. Real-time feedback on resource utilization and optimization opportunities is largely absent.

Additionally, there may be deficiencies in comprehensive workload visualization. Along these lines, critical integration points are missing, including model architecture details (layers, parameters, memory requirements), pod-level resource consumption, worker node distribution, and GPU-specific metrics (memory bandwidth, compute utilization, tensor core usage). This absence hinders effective workload optimization, leading to over-provisioning (waste), under-provisioning (OOM errors, job failures), and an inability to pinpoint performance bottlenecks.

Furthermore, there may be deficiencies in resource health monitoring. Along these lines, there may exist a critical lack of alerts for GPU temperature thresholds, thermal throttling, memory errors (ECC corrections, uncorrectable errors), power consumption anomalies, and PCIe bandwidth saturation. This results in undetected hardware degradation, job failures, the inability to perform proactive maintenance, and reduced hardware lifespan.

Also, there may exist a time-series analytics gap. Along these lines, capabilities for historical trend analysis of provisioning patterns, correlation between request parameters and actual usage, predictive analytics for future resource needs, and cost tracking/attribution per request/job are missing. This impedes data-driven capacity planning, optimization of resource allocation policies, and clarity on GPU investment ROI.

Additionally, there may exist an ML framework integration void. For example, a lack of native integration with experiment tracking platforms like WandB/MLflow prevents correlating infrastructure metrics with model performance and linking hyperparameter tuning with resource consumption. This necessitates manual correlation, delays optimization cycles, and compromises experiment reproducibility.

It should be further appreciated that there may be an administrator visibility crisis. As a current limitation, administrators are hampered by significant visibility gaps, impacting their ability to effectively manage multi-tenant environments.

Furthermore, there may be specific challenges such as multi-tenant resource management. Along these lines, there is no unified view of resource allocation across users/teams, no tracking of resource utilization by project/department, missing cost attribution/chargeback mechanisms, and a lack of fairness metrics for resource distribution. This prevents effective quota enforcement, data-driven capacity planning, and identification of resource hogs or underutilized allocations.

Additionally, there may be hierarchical drill-down absence. Along these lines, the inability to navigate from organization to team, user, slice, job, and individual GPU, coupled with a lack of contextual metric aggregation at each level, hinders the ability to trace resource allocation decisions. This complicates troubleshooting, delays problem identification, and extends Mean Time To Resolution (MTTR).

Also, there are demands in request lifecycle management. Along these lines, gaps in workflow, including no visual representation of request states, inability to modify in-flight requests, missing approval workflows, and no priority adjustment mechanisms, lead to rigid resource allocation, an inability to respond to changing business priorities, and excessive manual intervention.

There are also resource management inefficiencies. For example, there may be a constrained resource scheduling crisis. Along these lines, there may be a GPU scarcity problem. For example, high-end GPUs (A100, H100) are extremely expensive ($10,000-$40,000 each), yet typical utilization rates in production environments remain low (30-40%). The absence of intelligent scheduling exacerbates this, leading to resource starvation for some workloads while others remain idle.

Additionally, there may be specific challenges such as a lack of an abstraction layer. For example, direct Kubernetes GPU device plugin limitations and a lack of a unified API for heterogeneous GPU types mean hardware differences cannot be abstracted. This necessitates logical GPU resource pools, hardware-agnostic resource requests, and automatic mapping to physical resources.

Furthermore, there may be static cluster boundaries. Along these lines, GPUs are confined to specific Kubernetes clusters, preventing dynamic reallocation between clusters and the leveraging of idle resources elsewhere. Cross-cluster GPU federation, dynamic cluster membership, and workload migration capabilities are urgently needed.

Also, there may be inflexible time-sharing. For example, there may be the absence of temporal resource allocation, the inability to schedule future GPU usage, and an all-or-nothing allocation model limit efficiency. Time-slice based scheduling, advance reservation systems, and pre-emptible/guaranteed slots are critical.

As another resource management inefficiency, there may be dynamic provisioning deficiencies. With regard to manual pool management, the current process involves manual GPU assignment to static pools by administrators, without automatic rebalancing. Dynamic pool creation based on demand, automatic GPU migration between pools, and policy-driven pool management are essential.

With regard to configuration rigidity, reconfiguring a GPU node (e.g., from bare metal to MIG for a new workload) is a manual, hours-long process causing service disruption. Automated node reconfiguration, zero-downtime mode switching, and configuration templates/profiles are required.

With regard to a utilization optimization gap, using a large GPU (e.g., A100 80 GB) for small model inference without dynamic partitioning for multiple workloads results in massive resource waste (e.g., 10% capability usage). Dynamic GPU partitioning (MIG profiles), automatic workload consolidation, and right-sizing recommendations are needed.

As another resource management inefficiency, there may be network configuration challenges. For example, in the context of RDMA Network Management, manual RDMA configuration per allocation, error-prone network isolation setup, and lack of automatic cleanup on deallocation are significant hurdles. Automation requirements include dynamic RDMA network provisioning, automatic VLAN/subnet allocation, guaranteed network isolation, and automatic teardown/cleanup.

As yet another resource management inefficiency, in the context of inventory and health management, for static inventory systems, the absence of real-time hardware status updates, reliance on manual GPU availability tracking, and lack of automatic failure detection are problematic. Live hardware health monitoring, automatic bad GPU quarantine, and predictive failure analysis are crucial.

Additionally, in the context of configuration drift, no continuous compliance checking, reliance on manual configuration audits, and drift detection only after failures occur lead to instability. Continuous configuration validation, automatic remediation, and drift prevention mechanisms are essential.

Furthermore, there may be capacity planning blindness. Along these lines, there may be a lack of trend analysis. Missing data on historical utilization patterns, seasonal demand variations, and growth trajectory analysis leads to reactive capacity additions, either overprovisioning (waste) or underprovisioning (bottlenecks), and a lack of data-driven procurement decisions.

Also, there may be no predictive provisioning. Organizations wait for resource exhaustion, endure lengthy procurement cycles, and suffer business impact during shortages. Predictive demand modeling, proactive capacity triggers, and automated scaling recommendations are necessary.

These problems result in a significant quantified business impact.

In terms of business/financial impact, there may be resource underutilization cost which may be estimated at $2-5 million annually for medium-sized AI teams. Additionally, there may be manual management overhead which may require 3-5 full-time equivalents (FTEs) dedicated solely to GPU management. Furthermore, there May be job failure costs in which 20-30% of jobs may fail due to resource-related issues. Also, there may be delayed time-to-market with development cycles that are 40% longer due to resource wait times.

In terms of operational impact, in the context of the administrator burden, 60% of administrator time may be consumed by manual tasks. Regarding developer productivity loss, developers may spend 25% of their time waiting for resources. Regarding Mean Time To Resolution (MTTR), the MTTR for resource-related issues may be 4-6 hours. Regarding Service Level Agreement (SLA) violations, 15-20% of workloads may fail to meet SLAs due to resource constraints.

There may also be competitive disadvantages. Along these lines, there may be model training delays (e.g., model training may be 2-3 times longer than necessary). Additionally, there may be innovation throttling (e.g., resource constraints limit experimentation and innovation). Furthermore, there may be talent retention issues (e.g., developer frustration with infrastructure limitations can lead to talent attrition).

For root cause analysis, there may be architectural limitations, technology gaps, process deficiencies, etc. With regard to architectural limitations, there may be monolithic resource management (e.g., the absence of a clear separation between control and data planes), static configuration models (e.g., designed for traditional workloads, ill-suited for dynamic AI/ML environments), cluster-centric design (e.g., lacks native multi-cluster capabilities), and missing abstraction layers (e.g., direct hardware exposure without logical grouping or virtualization). With regard to technology gaps, there may be challenges in connection with an observability stack (e.g., a lack of GPU-aware monitoring solutions), automation frameworks (e.g., manual processes are not codified or automated), integration points (e.g., isolated tools without unified workflows), and an intelligence layer (e.g., absence of ML-driven optimization capabilities). With regard to process deficiencies, there may be reactive management (e.g., no proactive resource planning in place), manual workflows (e.g., over-reliance on human-dependent processes), siloed operations (e.g., different teams manage distinct aspects of the infrastructure in isolation), and no feedback loops (e.g., failure to implement learning from historical data).

Accordingly, the current state of GPU resource management within Kubernetes environments constitutes a significant obstacle to AI/ML innovation. Further limitations in conventional systems include static GPU allocation methods, only single-cluster resource management systems, basic autoscaling without workload-aware intelligence, and limited support for hybrid deployment models What is needed, therefore, is a way to address the above-mentioned issues.

Among these issues are inefficient GPU utilization in multi-cluster environments, the lack of dynamic resource allocation across heterogeneous infrastructure, the absence of intelligent scaling mechanisms for inference workloads, and complex multi-tenancy requirements in GPU-accelerated environments.

However, the above-mentioned issues are addressed at least in part by techniques which provide elastic GPU workflows which are herein described. In accordance with certain embodiments, such techniques are able to provide dynamic GPU resource allocation across multiple Kubernetes clusters, intelligent workload placement with multi-dimensional optimization, reinforcement learning-based inference endpoint scaling, and/or multi-tenant GPU workspace management, among other things.

Along these lines, such techniques provide for GPU cluster time slicing. In accordance with certain embodiments, elastic GPU service (EGS) implements dynamic GPU cluster time slicing, which abstracts GPU infrastructure across multiple clusters, dynamically allocates/reallocates GPU resources based on demand, associates GPU resources with user-specific “Slice VPCs” (virtual private clouds), automates node preparation and configuration, and significantly reduces manual SRE effort.

In accordance with certain embodiments, there is improved GPU utilization (quantify: e.g., 40-60% improvement), reduced inference latency for high-priority models, seamless multi-cloud/edge/DC GPU resource federation, and automated GPU provisioning with workload-aware scheduling.

Advantageously, the above deficiencies may be addressed at least in part by the following which are described herein as features, alternatives, options, etc. which may be implemented in a stand alone manner or combined. Such modifications, enhancements, and configurations are considered to belong to various embodiments.

The Elastic GPU Service (EGS) emerges as a pivotal and comprehensive platform, meticulously engineered to orchestrate and optimize GPU resources across diverse Kubernetes clusters. It directly confronts the pressing global challenge of scarcity in specialized GPUs, such as the NVIDIA A100, H100, B100, and B200, which are indispensable for advanced AI/ML workloads. By implementing an intelligent and dynamic framework for resource management and sophisticated scheduling, EGS dramatically enhances GPU availability and maximizes utilization, thus bridging a critical gap in the AI/ML ecosystem.

EGS is strategically positioned to fill a significant void left by existing Large Language Model Operations (LLM-Ops) tools and schedulers. While many prevalent tools adeptly handle the LLM lifecycle—from development and deployment to scaling and monitoring—they frequently fall short in the crucial areas of GPU scheduling and nuanced resource management across a multitude of users, intricate pipelines, and distributed clusters. Similarly, conventional schedulers are often confined to in-cluster job scheduling, lacking the broader scope required for enterprise-grade GPU management. This glaring oversight has cultivated a substantial demand among cloud providers, particularly those catering to large and medium-sized enterprises, for robust allocation mechanisms, efficient provision management, and seamless automation of GPU resources.

In accordance with certain embodiments, EGS rises to meet this profound need by offering a multi-faceted solution that:
Maximizes GPU Utilization and Monetization: It facilitates the immediate availability of pre-configured GPU nodes and pools, specifically optimized for demanding fine-tuning jobs. This agility significantly boosts GPU utilization rates, thereby driving enhanced monetization opportunities for cloud providers.
Empowers Premium Service Offerings: EGS enables cloud providers to deliver a premium, white-glove service to their most discerning and larger customers. This elevated service standard is built upon reliable and optimized GPU resource access, fostering stronger client relationships and competitive differentiation.
Streamlines Self-Service GPU Management: Through an intuitive and user-friendly self-service portal, EGS demystifies and simplifies GPU resource management, making it accessible and efficient for a much wider user base, from individual data scientists to large enterprise teams.

In accordance with certain embodiments, specific features, componentry, and/or alternatives may include:

### Key Concepts

EGS's robust architecture and functionality are built upon a foundation of several interconnected core concepts, each contributing to its comprehensive resource management capabilities in certain embodiments:
GPU Cluster Time-Slicing: A revolutionary approach to dynamically allocating and reallocating GPU resources.
EGS Slice VPC: A logical and isolated boundary for user workspaces within the EGS ecosystem.
Dynamic GPU Provisioning in a Slice VPC: The on-demand allocation of GPU resources into a user's isolated environment.
GPU Provision Requests Management (GPR): A sophisticated system for users to request and manage GPU resources.
GPU Inventory Schedule Management: Real-time tracking and scheduling of all available GPU assets.
AI Workload/GPU Observability: Comprehensive monitoring and insights into AI workloads and GPU performance.
GPU Monitoring and Remediation: Proactive identification and resolution of GPU-related issues.
Multi-Cloud Multi-Cluster EGS Slice VPC: The ability to span user workspaces and GPU resources across heterogeneous cloud environments and multiple Kubernetes clusters.
Insights and Trends from GPR Queues: Data-driven analytics derived from GPU provision request queues to inform resource planning.
Workspace Provision Requests: General requests for the provisioning of entire workspace environments.
Dynamic Node Pools and Nodes: The agile creation and management of GPU-equipped node pools and individual nodes.
Other concepts
   a. Scalable Inference Endpoints
   b. GPU scaling
   c. Smart Scaler for Inference Endpoints
   d. EGS API/SDK
   e. EGS Fine tuning workflows

Some embodiments introduce a sophisticated virtualization layer designed to revolutionize how developers interact with GPU resources. This layer ensures efficient and seamless access to GPUs, abstracting away the underlying complexities of diverse GPU hardware, various cloud environments, and multiple development frameworks. By providing this agnostic interface, we empower developers to focus on innovation without being constrained by infrastructure specifics.

### Main Features:

1. Efficient Shared GPU Usage: Maximize the utilization of your valuable GPU assets through intelligent resource sharing. Our virtualization layer enables multiple workloads or users to efficiently share a single physical GPU, dynamically allocating compute and memory resources as needed. This significantly improves GPU utilization rates, reduces idle time, and decreases the overall cost per GPU hour, making high-performance computing more accessible and economical.
2. Deep Observability: Gain unprecedented visibility into GPU utilization and performance. Our deep observability features provide real-time metrics, historical data, and detailed insights into every aspect of GPU operation, including compute usage, memory consumption, temperature, and power draw. This comprehensive monitoring allows for proactive issue resolution, performance optimization, and informed resource allocation.
3. GPU Cost/Usage Control: Optimize your GPU expenditure with granular control over usage and costs. Our system enables administrators to set budgets, define usage limits, and track spending across projects, teams, or individual users. Detailed reporting provides transparency into GPU consumption, helping to identify inefficiencies and allocate resources more effectively, ultimately leading to significant cost savings.
4. Tenancy, RBAC, Access Control: Establish secure and organized access to GPU resources with robust tenancy, Role-Based Access Control (RBAC), and comprehensive access control mechanisms. Our solution supports multi-tenancy, allowing multiple teams or departments to securely share the same GPU infrastructure without interference. RBAC enables the assignment of specific permissions based on user roles, ensuring that only authorized personnel can access and manage GPU resources. Fine-grained access control allows for precise management of who can utilize which GPUs, for what purposes, and under what conditions.
5. Inference Endpoints: Streamline the deployment and serving of AI models with integrated inference endpoints. Our platform facilitates the creation and management of dedicated endpoints for model inference, allowing developers to easily expose their trained models as scalable, low-latency services. These endpoints are optimized for performance and reliability, simplifying the integration of AI capabilities into applications and accelerating the path from model development to production deployment.
6. Smart Scaler: RL (reinforcement learning) based auto-scaling of AI/ML workloads

### GPU Cluster Time Slicing

Effective GPU resource management is not merely beneficial; it is absolutely crucial for achieving peak performance and drastically minimizing waste in the increasingly demanding domain of GPU-accelerated computing. GPU cluster time slicing represents a paradigm shift in this regard, dynamically allocating and reallocating GPU resources across a diverse landscape of multiple users, complex pipelines, and varied workloads. This ensures an unparalleled level of efficient GPU cluster utilization, transforming potential bottlenecks into fluid operational flows.

At its core, time slicing intelligently abstracts the underlying GPU infrastructure. It achieves this by dynamically provisioning and deprovisioning GPU resources, associated nodes, and intricate network configurations across one or more Kubernetes clusters. This powerful abstraction meticulously associates discrete GPU resources with specific user-defined “slices/workspaces” (typically represented as Virtual Private Clouds or VPCs) and their designated Kubernetes namespaces. This granular association facilitates the seamless provisioning and, crucially, the graceful removal of GPU nodes as workload demands fluctuate. Moreover, EGS automates the often-laborious preparation and setup of GPU nodes. This automation encompasses the intricate configuration of the GPUs themselves, the installation of essential plugins and operators, the deployment of Custom Resources (CRs), and the meticulous setup of network parameters. Such extensive automation profoundly reduces the manual effort traditionally borne by Site Reliability Engineers (SREs), allowing them to focus on higher-value tasks.

In accordance with certain embodiments, the key benefits of GPU cluster time slicing are manifold and impactful:
Scalable Management: EGS empowers the scalable management of an expansive array of GPU nodes distributed across numerous clusters. This ensures that users consistently have access to available resources precisely when and where they are needed, irrespective of the underlying physical location or cluster topology.
Enhanced Isolation: The system provides significantly better isolation through the creation of dedicated GPU slices, meticulously tailored to meet the unique requirements and security considerations of individual users or teams. This prevents resource contention and enhances data security.
Comprehensive Observability: EGS offers intuitive dashboards that provide deep, actionable insights into every facet of the GPU environment. These dashboards detail slices, active users, running workloads, individual GPUs, and a rich array of associated metrics. This includes sophisticated hot-spot detection capabilities, real-time event monitoring, and proactive alerting mechanisms for truly anticipatory management.
Optimized Resource Management: EGS excels in constrained GPU resource management and sophisticated scheduling. This includes the efficient handling of GPU provision requests, intelligent scheduling for each GPU node based on current demand and availability, and even predictive analytics for estimating wait times before deployment.
Automated Lifecycle: The automation of the entire lifecycle of GPU resource and pool provisioning is a cornerstone of EGS. This not only dramatically improves overall utilization but also dynamically configures and reconfigures nodes and networks on the fly, effectively managing GPU resources across distributed Kubernetes clusters with minimal human intervention.
Flexibility: A standout feature is the unparalleled flexibility to dynamically insert or remove nodes and entire pools from slices. This, coupled with the seamless reconfiguration of NVIDIA Multi-Instance GPU (MIG) or virtual GPU (vGPU) plugins, ensures that GPU clusters remain exceptionally agile and responsive to evolving workload demands. This inherent adaptability significantly reduces GPU wastage and dramatically increases operational efficiency.

### Comprehensive GPU Request Management

The backbone of GPU resource allocation within EGS is the EGS control plane's GPU requests (GPR) manager, a sophisticated component responsible for the entire lifecycle management of GPU requests. Upon submission, GPU requests are strategically inserted into a pending requests queue, with their placement and estimated wait time determined by a highly intelligent enqueue logic. This logic meticulously considers a multitude of factors to optimize resource allocation, including the current GPU inventory availability, existing allocations, assigned priority levels, fairness considerations across users and teams, and the current state of other requests already in the queue.

A core element of this management system is the EGS Queue Manager (QueueMgr), a dedicated component that maintains a meticulously ordered queue of pending GPR requests based on an integer priority number. The QueueMgr provides a rich and efficient set of APIs, allowing other components within the EGS system to seamlessly interact with and leverage its queuing capabilities. The GPR manager, working in tandem with the QueueMgr, plays a dynamic role in moving GPR requests in and out of the queue, all while diligently managing the GPU resource inventory and its intricate allocation.

### Core GPR Attributes:

Number of GPU nodes: Total GPU nodes requested
Number of GPUs per node: GPU count per individual node
GPU type: Specific GPU model (e.g., A100, H100, B200, A10, AMD MI300x etc.)
GPU memory: Memory requirements per GPU.
Workspace: Target Slice VPC for allocation
Cluster: Target cluster for provisioning
Exit duration: Reservation time period
Priority: Integer priority level for queue ordering
Preemptible: true/false
Idle timeout: duration

Auto GPR: detect workloads deployed in the workspace and create GPR request for GPU provisioning for the workload.

### Overview

The EGS Queue Manager (QueueMgr) is responsible for maintaining a queue of pending GPR (General Purpose Request) requests, organized by an integer priority number. It offers a comprehensive and efficient set of APIs, enabling other EGS system components to interact with it. The GPR Manager within the EGS system handles the movement of GPR requests into and out of the queue, while also managing and allocating GPU resources.

### Priority Queue

In some embodiments, the EGS system admits and stores GPRs with varying priorities in the queue. These GPRs are processed based on their priority, with higher priority GPRs being serviced before lower priority ones. The EGS system's Administrator has the capability to increase the priority of any GPR currently in the queue. The QueueMgr is designed to store GPRs efficiently, ensuring that extraction and rearrangement operations based on priority are performed without causing processing delays in the system.

A priority queue will be utilized to store GPRs according to their assigned priorities. This priority queue is optimized for time and space efficiency when performing operations such as getting, inserting, updating, deleting, and rearranging elements within the queue.

GPRs with equal priorities can be stored in a max-heap data structure. However, storing them in lists offers greater scalability, as max-heaps are typically array-based in memory (e.g., Go slices). This approach also provides flexibility in managing GPRs of the same priority.

Optimally and deterministically solving resource allocation problems with multiple input factors (e.g., number of GPUs requested, exit duration, GPR creation/submission time) is challenging. The problem simplifies significantly if each GPR has a unique priority, allowing for a pre-determined processing order. However, the complexity of allocation and scheduling increases when all requests have the same priority and maximum resource utilization is a goal. Nonetheless, several options can be considered.

### Best-Effort FIFO Allocation

In this approach, when selecting a GPR from multiple equal-priority GPRs, the decisive factor is the order of creation and insertion into the queue. The selection also depends on the current inventory availability, thus “best-effort.” Consider the following example with five equal-priority GPRs:

If 4 GPUs are available for allocation, Best-Effort FIFO would select GPR-x1, which requires 3 GPUs, as it is the first in the queue that can be satisfied. In the subsequent allocation loop, with 1 GPU remaining, GPR-x3 would be chosen over GPR-x4 to maintain the FIFO principle.

### Greedy Allocation

In problems that involve devising a method for optimally distributing or allocating a contentious resource, greedy algorithms have been shown to provide optimal solutions. Greedy algorithms make choices that look best at the current moment, making a locally optimal decision and hoping that it will lead to a globally optimal solution.

In EGS, the optimisation problem could be stated as follows: Satisfy as many GPRs as possible along with ensuring efficient utilisation of GPUs (without leaving any GPUs idle as much as possible).

In some embodiments, there are a couple of invariants in GPRs that could be used to make greedy choices:
(1) Number of GPUs requested
(2) Exit duration

If we consider the number of GPUs as a factor to make greedy choices, the goal would be to fit in as many GPRs as possible in the number of unallocated GPUs at a given point of time. For example, consider the following scenario:

There are 5 GPRs of the same priority with a certain number of GPUs requested in each of them. At a given point of time, the inventory has 4 GPUs that can be allocated. The greedy method would try to satisfy as many GPRs as possible with the currently available inventory, so it will choose GPRs x3, x4 and x5, instead of x2 which might have been submitted earlier than all the other GPRs that could be satisfied with 4 GPUs.

With this approach of greedy allocation hinged on satisfying as many GPRs as possible, we could encounter a number of issues:
(1) Starvation: Trying to maximise the number of GPRs that could be satisfied, GPRs with lower number of GPUs would be preferred. The GPRs that need higher number of GPUs will end up living longer in the queue.
(2) Resource wastage: In some cases, the greedy method of satisfying the maximum number of GPRs can lead to GPUs remaining idle and unused. In the above example, if we had 10 GPUs available for allocation, the greedy method would end up choosing x2, x3, x4 and x5 (4+1+1+2=8), allocating 8 GPUs among 4 GPRs and leaving 2 unused while we could have selected x1, x2 and x3 (5+4+1=10) utilising all 10 GPUs among 3 GPRs.

If we consider the exit duration of GPRs to make greedy choices, the GPR with the earliest exit time would be selected. In the following example, there are five equal priority GPRs in the queue and we have 5 GPUs available for allocation.

The greedy algorithm would choose GPR-x2 with the earliest exit duration, at the cost of leaving 1 GPU unused. Similar to using the number of GPUs as the decisive factor, the earliest exit duration can also lead to starvation and resource wastage. But the premise of greedy algorithms is that if we average over a large sample size (large number of allocation decisions over a period of time), the locally optimal choices indeed lead to satisfying as many GPRs as possible and with superior resource usage pattern.

### The Power of the Priority Queue

A fundamental principle governing GPR processing in EGS is the implementation of a robust priority queue. This design ensures that GPRs with varying priority levels can be admitted and stored within the queue, with a strict adherence to processing order: higher priority GPRs are invariably serviced before those with lower priorities. For scenarios requiring immediate attention, EGS provides an administrative capability, allowing an Admin to elevate the priority of any GPR currently residing in the queue. The QueueMgr is engineered to store GPRs in a manner that facilitates highly efficient extraction and rearrangement based on their priorities, thereby preventing any processing delays within the system.

The underlying mechanism for storing GPRs based on their assigned priorities is indeed a specialized priority queue data structure. This sophisticated queue is optimized to perform time and space-efficient operations for critical functions such as retrieving, inserting, updating, deleting, and rearranging elements, ensuring smooth and rapid processing of GPU requests.

### Max Min Fairness Allocation

In some embodiments, EGS implements multiple allocation algorithms: priority based, max-min based, priority with max-min, priority with greedy, priority with FIFO, etc.

For Max-Min fairness based algorithms there are 2 modes:
without any priority considerations
With priority consideration

### Max-Min Fairness Allocation Algorithm

In some embodiments, the EGS system implements a sophisticated min-max fairness allocation algorithm that works in conjunction with the priority-based queue management to ensure equitable resource distribution across users, teams, and projects while maintaining system efficiency. This algorithm addresses the critical challenge of preventing resource monopolization by any single entity while ensuring that high-priority workloads receive appropriate precedence.

Fairness Principles and Integration with Priority Queue

In some embodiments, the max-min fairness algorithm operates on the fundamental principle that no user or team should receive more GPU resources than necessary while others are starved, subject to priority constraints. Within the EGS framework, this algorithm functions as a secondary optimization layer that operates after initial priority-based sorting. When multiple GPRs (GPU Provisioning Requests) share the same priority level, the min-max fairness algorithm determines the optimal allocation order to maximize overall system fairness.

In some embodiments, the algorithm maintains dynamic fairness metrics for each user, team, and project, tracking their current resource consumption, historical allocation patterns, and pending request volumes. These metrics are continuously updated by the GPR manager in collaboration with the inventory schedule management service, ensuring real-time accuracy in fairness calculations.

### Algorithm Mechanics and Implementation

In some embodiments, the max-min fairness allocation process begins by calculating a “fair share” baseline for each entity (user/team/project) based on their aggregate resource quotas and current system capacity. The algorithm then iteratively allocates resources to under-allocated entities, progressively increasing their allocation until either all entities reach their fair share or system capacity is exhausted.

During each allocation cycle, the QueueMgr identifies all GPRs at the current priority level and groups them by requesting entity. The algorithm calculates each entity's current allocation deficit (difference between fair share and current allocation) and prioritizes GPRs from entities with the largest deficits. This ensures that resources flow first to the most under-allocated entities, gradually equalizing resource distribution across all participants.

For entities that have exceeded their fair share, their GPRs are deprioritized within the same priority level, ensuring they do not receive additional resources until other entities catch up. However, critical exceptions exist for high-priority administrative requests or emergency allocations, which can override fairness constraints when necessary.

### Dynamic Adaptation and Temporal Considerations

In some embodiments, the min-max fairness algorithm incorporates temporal windowing to account for varying workload patterns and usage cycles. Rather than considering only instantaneous allocation states, the system maintains rolling averages of resource consumption over configurable time windows (typically 24-hour and 7-day periods). This temporal awareness prevents short-term usage spikes from permanently affecting an entity's fairness standing and allows for natural load balancing over time.

In some embodiments, the algorithm also adapts to changing system conditions, such as node failures, maintenance windows, or capacity expansions. When GPU inventory changes, the fair share calculations are immediately recalculated, and pending allocations are reordered accordingly. This dynamic adaptation ensures that fairness remains optimal even as the underlying infrastructure evolves.

Integration with Slice VPC Management

In some embodiments, within the context of Slice VPC provisioning, the min-max fairness algorithm coordinates with the aiOps Operator to ensure that Slice allocations across different teams and projects maintain fairness principles. Since each Slice VPC can accommodate only one GPR at a time, the algorithm considers the duration and resource intensity of requested Slices when making fairness calculations. Longer-duration requests from entities that have received minimal recent allocations are prioritized over shorter requests from entities that have recently consumed significant resources.

In some embodiments, the algorithm also implements “fairness debt” tracking, where entities that have been denied resources due to higher-priority requests accrue fairness credits that improve their position in subsequent allocation cycles. This mechanism ensures that temporary priority-based preemption does not permanently disadvantage lower-priority but resource-starved entities.

Max-Min Fairness Algorithm for Priority-Agnostic Allocation In accordance with some embodiments, in a pure max-min fairness allocation system without priority considerations, the EGS GPR manager implements an algorithm that maximizes the minimum resource allocation across all requesting entities, ensuring that no user or team receives disproportionately fewer resources than others. The algorithm begins by calculating an initial equal distribution of available GPU resources among all active requesters, then iteratively refines this allocation by identifying entities whose actual resource demands are lower than their fair share allocation. The excess capacity from these under-demanding entities is redistributed proportionally among the remaining entities that can utilize additional resources, with the redistribution process continuing until no further reallocation can improve the minimum allocation received by any entity. This approach guarantees that the allocation is max-min fair, meaning that no entity can receive more resources without reducing the allocation of another entity that currently has an equal or smaller allocation. The algorithm maintains allocation stability by ensuring that once an entity reaches its maximum utilizable capacity or fair share ceiling, its allocation remains fixed while the remaining resources are redistributed among entities that can still benefit from additional GPU resources, thereby achieving optimal resource utilization while maintaining strict fairness across all participants in the system.

Comparison: Max-Min Fairness with Priority vs. Without Priority

### Algorithm Structure and Complexity

With Priority: In some embodiments, the max-min fairness algorithm with priority operates as a two-stage optimization process where requests are first segregated into priority buckets, and fairness calculations are performed within each priority level. The GPR manager must maintain separate fairness metrics for each priority tier, creating a hierarchical allocation structure where higher-priority requests are always served before lower-priority ones, regardless of fairness considerations across tiers. This approach requires more complex data structures and processing logic, as the QueueMgr must track both priority ordering and fairness state within each priority band.

Without Priority: In some embodiments, the priority-agnostic max-min fairness algorithm implements a single-stage optimization that treats all GPU requests equally, focusing solely on achieving optimal resource distribution across all entities. The algorithm maintains a unified fairness calculation without hierarchical considerations, resulting in simpler implementation and reduced computational overhead. All requests compete on equal footing based purely on current allocation deficits and resource demands.

### Resource Allocation Behavior and Outcomes

With Priority: In some embodiments, this approach ensures that critical, time-sensitive workloads receive immediate attention while maintaining fairness among requests of similar importance. However, it can lead to systematic starvation of lower-priority requests during periods of high demand from higher-priority users. The system may achieve sub-optimal overall fairness since lower-priority entities may never receive their fair share if higher-priority demand consistently exceeds available capacity. The algorithm provides predictable service guarantees for high-priority workloads but offers no fairness guarantees across priority boundaries.

Without Priority: In some embodiments, pure max-min fairness guarantees that no entity will be systematically starved of resources, ensuring long-term fairness across all users and teams. Every requesting entity is guaranteed to eventually receive resources proportional to their demand and the system's capacity constraints. However, this approach cannot distinguish between urgent production workloads and experimental tasks, potentially causing critical business operations to wait behind less important requests. The system achieves optimal overall fairness but lacks the ability to respond to varying business criticality.

### Practical Trade-offs and Use Cases

With Priority: In some embodiments, this model is essential for production environments where certain workloads (model inference serving, critical research deadlines, customer-facing applications) must take precedence over routine tasks. It provides administrators with the flexibility to ensure business-critical operations receive guaranteed resource access while maintaining fairness within each importance tier. The approach works well in enterprise environments with clearly defined service level agreements and hierarchical resource access policies.

Without Priority: In some embodiments, this approach is ideal for research environments, academic institutions, or collaborative development settings where all users should have equal access to computational resources over time. It prevents the accumulation of “resource debt” by any entity and ensures democratic access to GPU infrastructure. However, it may be unsuitable for production environments where business impact varies significantly across different workload types, as it cannot accommodate urgent requests that need to bypass normal fairness considerations.

### Utility Function for Max-Min Fairness Algorithm

In some embodiments, a utility function in max-min fairness represents the satisfaction or benefit that an entity (user, team, or application) derives from their allocated resources. The goal of max-min fairness is to maximize the minimum utility across all participants.

### Mathematical Definition

For a max-min fairness algorithm, the utility function typically takes the form:

$$▯U\_i ( x\_i ) = f ( x\_i , d\_i , w\_i )$$

### □Where:

U_i=Utility for entity i
x_i=Resources allocated to entity i
d_i=Demand/request from entity i
w_i=Weight/priority factor for entity i

### Core Utility Function Concept

In accordance with certain embodiments, a utility function measures the “satisfaction” or “benefit” an entity receives from their allocated resources. In max-min fairness, the goal is to maximize the minimum utility across all participants.

### Common Utility Functions for GPU Allocation:

$$Linear Utility : U\_i ( x\_i ) = min ( x\_i , d\_i ) . \qquad 1$$

Simple and direct-utility equals allocation up to demand
Perfect for fixed GPU requirements

$$Normalized Satisfaction : U\_i ( x\_i ) = x\_i / d\_i . \qquad 2$$

Measures fraction of demand satisfied (0 to 1)
Enables fair comparison across different request sizes

$$Weighted Utility : U\_i ( x\_i ) = w\_i \times min ( x\_i , d\_i ) . \qquad 3$$

Incorporates business priorities
Allows differentiation based on SLA tiers or user importance

$$Logarithmic Utility : U\_i ( x\_i ) = log ( 1 + x\_i ) . \qquad 4$$

Provides diminishing returns
Naturally promotes resource sharing

### GPU-Specific Enhancements:

Multi-dimensional utility that considers GPU count, memory, and type
Time-aware utility that decreases with waiting time to prevent starvation
Fairness debt tracking that gives preference to historically under-allocated users
Workspace constraints that ensure GPU type and other attributes compatibility

### In the EGS Context:

In some embodiments, the utility function would combine multiple factors:

$$▯U\_final = Base\_utility \times Priority\_weight \times Time\_factor \times ( 1 + Fairness\_debt ) \times Workspace\_compatibility$$

□This ensures that the allocation algorithm considers not just the immediate request, but also historical fairness, urgency, business priorities, and system constraints.

The max-min fairness algorithm then uses these utility values to ensure that no user's utility can be improved without reducing the utility of someone who already has equal or less utility-achieving a mathematically fair distribution of GPU resources.

In accordance with certain embodiments, there are utility functions specifically designed for the EGS system's max-min fairness with priority algorithm for GPR allocation.

Along these lines, there may be a comprehensive utility function specifically designed for the EGS system's priority-based max-min fairness algorithm for GPR allocation.

In accordance with certain embodiments, these are Key Features of the EGS Utility Function:

### Master Utility Function:

$$▯U\_i ( GPR\_i , x\_i , t ) = P ( priority\_i ) \times U\_base ( x\_i , d\_i ) \times F\_fairness ( i , t ) \times T\_decay ( wait\_i ) \times W\_constraints ( i )$$

### □Core Components:

1. Priority Multiplier P(priority_i):
   HIGH: 10\hat{ }6, MEDIUM: 10\hat{ }3, LOW: 1
   Ensures absolute priority ordering-HIGH priority GPRs always have higher utility
2. Base Satisfaction U base:
   Multi-dimensional: considers nodes, GPUs per node, and memory
   Range: [0, 1] representing fraction of demand satisfied
   Weighted combination: 40% nodes, 40% GPUs, 20% memory
3. Fairness Adjustment F_fairness:
   Tracks historical under-allocation over 7-day window
   Compensates teams/users who have been starved
   Range: typically [0.5, 2.0] to prevent extreme adjustments
4. Time Decay T decay:
   Increases utility for long-waiting requests
   Prevents indefinite starvation within same priority
   Range: [1.0, 2.0] based on wait time vs SLA
5. Workspace Constraints W_constraints:
   Binary (0 or 1) enforcement of hard limits
   Checks GPU type compatibility and other GPR/GPU attributes, workspace capacity, team quotas

### Two-Stage Algorithm:

Stage 1: Segregate GPRs by priority (HIGH, MEDIUM, LOW)
Stage 2: Within each priority level, apply max-min fairness using the utility function to ensure equitable distribution

### Key Properties:

Strict priority ordering maintained through large multiplier gaps
Fairness within priority through max-min allocation
Historical fairness via debt tracking
Starvation prevention through time decay
Hard constraint enforcement for workspace limits

This design ensures that critical workloads (HIGH priority) always get resources first, while maintaining fairness among requests at the same priority level and preventing any team from being permanently starved of resources.

Further details in accordance with certain embodiments will now be provided with reference to FIGS. 10 through 12. Such figures show the sequence of GPR queue management and allocation with priority-based max-min fairness. It should be noted that such figures show the sequence of GPR queue management and allocation with priority-based max-min fairness using the utility function.

### Main Flow Phases:

### Phase 1: GPR Submission and Initial Processing

New GPR creation with priority and resource requirements
Validation against workspace limits and GPU compatibility
Initial wait time calculation
Queue insertion based on priority level
User notification with estimated provisioning time

### Phase 2: Priority Queue State

The system maintains three separate queues:
HIGH Priority Queue (P=10\hat{ }6)—Critical workloads
MEDIUM Priority Queue (P=10\hat{ }3)—Standard workloads
LOW Priority Queue (P=1)—Best-effort workloads

### Phase 3: Periodic Allocation Process

### Stage 1: Priority-Based Processing

Check available GPU inventory
Process queues in strict priority order: HIGH→MEDIUM→LOW
Each priority level gets exclusive access to resources before moving to next

### Stage 2: Max-Min Fair Allocation Within Priority

Calculate utility for each GPR: U_i=P×U_base×F_fairness×T_decay×W_constraints
Find GPR with minimum utility
Allocate fair share to increase minimum utility
Recalculate utilities and repeat until resources exhausted

### Stage 3: Results and Updates.

Mark allocated GPRs as ready for provisioning
Update queue by removing allocated GPRs
Update fairness metrics and historical debt
Trigger GPU provisioning through GPR Manager
Recalculate wait times for all pending GPRs

### Key Properties Maintained:

1. Strict Priority Order-Large multiplier gaps ensure HIGH always beats MEDIUM/LOW
2. Max-Min Fairness-Within each priority, maximize the minimum utility
3. Historical Fairness-Track and compensate for past under-allocation
4. Constraint Compliance-Enforce workspace limits and GPU compatibility
5. Time-Based Urgency-Prevent starvation through wait time decay
6. Dynamic Adaptation-Continuous rebalancing based on system state
7. Pareto Efficiency-Optimal resource utilization

### GPR Queue Management and Allocation Sequence Flow

Priority-Based Max-Min Fairness with Utility Function

### GPR Queue Management and Allocation Flow

With reference to FIG. 12 and in accordance with some embodiments, there is shown a continuous process loop that repeats periodically (every T minutes), constantly adapting to new GPRs, changing inventory, and evolving fairness metrics to ensure both priority-based service and fairness within each priority tier.

Dynamic GPU Provisioning within a Slice Workspace

In some embodiments, the provisioning of GPU resources within a Slice is a dynamic and meticulously orchestrated process. The GPR manager proactively and periodically checks with both the Inventory and Queue managers to identify the next eligible GPR allocation for provisioning. Once a GPR is successfully allocated, the system precisely identifies the resources required to fulfill the request. The GPR manager then collaborates seamlessly with the worker cluster's EGS component, the aiOps Operator, to bring the provisioning process to completion. This collaboration involves the GPR manager creating appropriate Custom Resources (CRs) that instruct the aiOps Operator to provision the necessary GPU nodes directly into the worker cluster's designated Slice VPC.

It's noteworthy that in single-cluster EGS deployments, the EGS control plane components and the EGS worker components (specifically, the aiOps Operator) are deployed within the same cluster, albeit segregated into distinct namespaces to maintain operational isolation and organization.

The aiOps Operator serves as the primary custodian for the lifecycle management of GPR provisioning within the cluster. Its responsibilities extend to managing the seamless entry and exit of GPU nodes from the Slice VPC. Furthermore, it continuously monitors the health and performance of the GPU nodes, meticulously tracking vital metrics such as temperature, power consumption, and utilization. In the event that these critical metrics cross predefined error thresholds, the aiOps Operator promptly generates relevant events, ensuring timely alerts and proactive intervention.

During the initial GPU provisioning phase, the aiOps Operator undertakes several crucial preparatory steps, including node preparation, network configuration, and rigorous latency checks. In the pre-provisioning stage, it diligently verifies that the nodes are functioning correctly, are properly networked, and executes NCCL (NVIDIA Collective Communications Library) tests to thoroughly assess network latency. It maintains a constant vigilance over NCCL latency across all nodes within the Slice VPC. The integration of nodes into the Slice VPC is achieved by provisioning appropriate affinity and anti-affinity rules, among other configurations, directly into the Slice namespaces. Once the GPUs are successfully provisioned to the Slice, users can then execute their AI workloads, requesting GPUs within the associated Slice namespaces. Any workloads (whether pods, jobs, or other computational units) that were in a pending state will then acquire the requested GPU resources, and the Kubernetes scheduler will transition them from pending to a running state. To keep users informed, EGS sends timely notifications (both on the Portal and via Slack) as soon as the provisioning process is complete. Furthermore, standard K8s events are also generated, providing a detailed audit trail.

A critical aspect of Slice VPC management is that a single Slice VPC can only have one GPR provisioned at any given time, ensuring dedicated resource allocation and preventing potential conflicts.

Throughout the lifetime of a provisioned GPR, the aiOps Operator actively generates K8S events and, if configured, sends Slack notifications. This proactive communication provides users with real-time updates and a clear understanding of the remaining time for their current GPR provisioning.

At the culmination of the provisioned period (determined by the reservation duration and start time), the GPU nodes are gracefully removed from the Slice. Prior to their removal, these nodes undergo a draining process, preparing them for subsequent allocation to another Slice VPC. During this exit phase, any running workloads (pods, jobs, etc.) that are still actively utilizing the GPUs will be restarted and transition back to a pending state. It is a fundamental expectation that AI workloads are designed to periodically generate checkpoints, ensuring that in the vast majority of cases, the training or fine-tuning (or other functions) is complete, making it safe to remove the GPU nodes from the Slice without significant data loss.

### Sophisticated GPU Inventory Schedule Management

In some embodiments, the efficiency and accuracy of GPU resource allocation within EGS are significantly bolstered by the EGS inventory schedule management service. This vital service meticulously maintains comprehensive details about all GPU nodes and GPU devices, including their attributes. It also meticulously tracks network configurations and other related infrastructural information. Crucially, it maintains a detailed schedule of all GPU nodes, offering a clear overview of their availability and utilization. This service exposes a rich set of APIs that are consumed by the GPU requests manager and other relevant services, enabling them to retrieve critical information about nodes, GPU specifics, and their respective schedules.

EGS diligently monitors and keeps track of all GPU nodes across all clusters that are associated with EGS projects. The worker aiOps operator plays a continuous role in updating the node details to the inventory schedule management service, ensuring that the inventory data is always current and accurate.

Ultimately, the EGS inventory schedule management service is instrumental in providing precise, real-time wait time estimates for any given GPU request. This accuracy is a direct result of its comprehensive data, dynamic updates, and sophisticated scheduling algorithms, allowing users to make highly informed decisions about their GPU resource needs.

### EGS: Orchestrating GPU Resource Allocation

In some embodiments, in the intricate ecosystem of GPU resource allocation, the EGS (Elastic GPU Service) plays a pivotal role in managing user requests and orchestrating the provisioning of GPU nodes within Slices and across various clusters. The journey begins with users initiating GPU requests through the intuitive EGS User portal, where the EGS control plane acts as the central intelligence, meticulously managing the queue of these requests across diverse Slices, user teams, and underlying clusters. A key feature at this initial stage is the provision of an estimated provisioning time by the EGS control plane's backend, offering users a clear expectation of when their requested resources will become available.

### Priority Queue: Intelligent Request Prioritization

In some embodiments, at the heart of the EGS's efficiency lies the Priority Queue, a sophisticated mechanism for handling incoming GPRs (GPU Provisioning Requests). GPRs, each assigned a specific priority level, are admitted and stored in this queue. The system ensures that GPRs are processed strictly in the order of their priorities, with higher priority GPRs receiving service before lower priority ones. This guarantees that critical workloads are accelerated. The EGS system empowers administrators with the crucial ability to dynamically increase the priority of any GPR already residing in the queue, allowing for real-time adjustments to meet evolving demands. The QueueMgr, a vital component, is engineered to store GPRs in a manner that facilitates exceptionally efficient extraction and rearrangement based on their priorities. This design is paramount in preventing processing delays and maintaining system responsiveness. The underlying priority queue data structure is chosen for its time and space efficient operations, enabling rapid retrieval, insertion, updating, deletion, and rearrangement of elements within the queue.

### Dynamic GPU Provisioning in a Slice: Seamless Resource Allocation

In some embodiments, the GPR manager serves as the orchestrator of dynamic GPU provisioning. It constantly liaises with the Inventory and Queue managers to secure the next GPR allocation for provisioning. Upon allocation, the manager meticulously identifies the precise resources required to fulfill the request. The GPR manager then collaborates with the ‘aiOps Operator’, a key EGS component within the worker cluster, to execute the provisioning process. This collaboration involves the GPR manager creating appropriate Custom Resources (CRs) that instruct the ‘aiOps Operator’ to seamlessly integrate the GPU nodes into the worker cluster's Slice VPC.

Deployment Architecture: Single vs. Multi-Cluster

In some embodiments, in single-cluster EGS deployments, the EGS control plane components and the EGS worker components (specifically the ‘aiOps Operator’) are co-located within the same cluster, albeit in distinct namespaces. This streamlined architecture simplifies deployment and management for smaller-scale operations.

The ‘aiOps Operator’: Lifecycle Management of GPU Nodes

In some embodiments, the ‘aiOps Operator’ is the linchpin of GPR provisioning within a cluster, assuming full responsibility for the lifecycle management of these critical resources. It meticulously oversees the entry and exit of GPU nodes from the Slice VPC, ensuring their seamless integration and graceful removal. Beyond provisioning, the ‘aiOps Operator’ continuously monitors the health and performance of GPU nodes, tracking vital metrics such as temperature, power consumption, and utilization. It is also equipped to generate events when predefined error thresholds for these important metrics are breached, enabling proactive issue detection and resolution.

### GPU Node Entry and Pre-Provisioning:

In some embodiments, during the entry phase of GPU provisioning, the ‘aiOps Operator’ undertakes a series of crucial tasks. It performs comprehensive node preparation, ensuring that the hardware is configured optimally. Network preparation is also a key responsibility, guaranteeing robust connectivity for the GPU nodes. A critical step is the latency check, where the ‘aiOps Operator’ runs NCCL (NVIDIA Collective Communications Library) tests to assess the communication latency across the nodes. During pre-provisioning, the operator verifies that the nodes are functioning correctly and are properly networked. It continually monitors NCCL latency across all nodes within the Slice VPC, ensuring consistent high-performance communication. Nodes are strategically added to the Slice VPC by applying appropriate affinity/anti-affinity rules, ensuring optimal resource placement within the Slice namespaces.

### User Workload Execution and Notifications:

In some embodiments, once GPUs are successfully provisioned to a Slice, users can readily execute their AI workloads, requesting GPUs within the associated Slice namespaces. Any workloads (pods, jobs, etc.) that were previously in a pending state will then acquire the requested GPU resources, and the Kubernetes scheduler will transition them from pending to a running state. To keep users informed, EGS dispatches notifications via the Portal and Slack channels upon successful completion of the provisioning process. Additionally, standard Kubernetes events are generated, providing a granular audit trail of the provisioning lifecycle.

### Slice VPC Specifics and Real-time Updates:

In some embodiments, a critical design constraint is that a Slice VPC can accommodate only one GPR at any given time. This ensures dedicated resource allocation and simplifies management. The ‘aiOps Operator’ plays a crucial role in providing real-time updates to users throughout the provisioned GPR's lifecycle. It generates K8s events and, if configured, Slack notifications, offering users a continuous sense of the progress and remaining time for their GPR provisioning.

### GPU Node Exit and Workload Management:

In some embodiments, at the designated provision exit time, determined by the reservation duration and start time, the GPU nodes are gracefully removed from the Slice. Before removal, the nodes are meticulously drained to prepare them for subsequent allocation to another Slice VPC. During the exit process, any running workloads (pods, jobs, etc.) that are still utilizing the GPUs will be restarted and transition to a pending state. It is a fundamental expectation that AI workloads have periodically generated checkpoints, ensuring that in most scenarios, training, fine-tuning, or other functions are complete, making it safe to remove the GPU nodes from the Slice without data loss.

### GPU Inventory Schedule Management: Comprehensive Resource Tracking

In some embodiments, the EGS inventory schedule management service is the authoritative source for detailed information regarding GPU nodes, GPU devices, and their associated attributes. It also meticulously maintains network and other related configuration information. Crucially, it provides a comprehensive schedule of the GPU nodes, outlining their availability and allocation. This service exposes a suite of APIs to the GPU requests manager and other internal services, enabling them to efficiently retrieve node and GPU details, along with their respective schedules.

In some embodiments, EGS diligently tracks all GPU nodes across every cluster associated with EGS projects. The worker ‘aiOps Operator’ continuously updates the node details to the inventory schedule management service, ensuring that the information is always real-time and accurate. This real-time data from the EGS inventory schedule management is instrumental in providing users with an accurate real-time wait time estimate for their GPU requests, further enhancing the transparency and predictability of the EGS system.

Initiating a GPU Request through the EGS User Portal

In some embodiments, users interact with the EGS User portal to initiate GPU requests for their respective Slices. This intuitive interface serves as the primary gateway for accessing shared GPU resources. The EGS control plane, acting as the central orchestrator, meticulously manages the queue of these GPU requests, distributing them efficiently across various Slices (representing different user teams) and underlying clusters. Upon the creation of a GPU request, the EGS control plane, leveraging its robust backend systems, provides users with an estimated provisioning time. This foresight allows users to plan their workflows effectively, especially when dealing with high-demand resources.

### Navigating Resource Constraints and Wait Times

In some embodiments, in environments with highly sought-after GPU resources, such as A100 or H100 GPUs, it is common to experience a wait time. This is particularly true in most organizational clusters where these specialized resources are shared. Users have the flexibility to create multiple GPU requests, each with its own estimated provisioning time, allowing for concurrent or staggered resource allocation. When submitting a GPU request, users are empowered to define critical parameters, including the desired GPU shape (e.g., specific GPU models or configurations), the number of nodes required, the priority level of their request, any specific model parameters, network requirements, and the anticipated reservation duration. Crucially, the EGS system proactively presents the estimated wait time for the GPU request. Only if the user acknowledges and accepts this estimated wait time can they proceed with submitting the request, ensuring transparency and informed decision-making.

### Optimizing GPU Selection Across Diverse Cluster Configurations

In some embodiments, for clusters that support a variety of GPU shapes (i.e., multiple node pools with different GPU configurations), the EGS system offers an advanced capability. Users can query the wait times across all available GPU shapes within the cluster. This feature is invaluable for optimizing resource allocation. By displaying the wait times for various GPU shapes, EGS enables users to make an informed choice, selecting the GPU configuration that best aligns with the specific requirements and time constraints of the job they intend to deploy. This flexibility maximizes resource utilization and minimizes idle time for critical workloads.

### Dynamic Management of GPU Requests: Edit, Delete, and Early Release

The EGS system provides users with comprehensive control over their GPU requests. Before a request is provisioned, users retain the ability to edit or even delete it, accommodating changes in project requirements or priorities. Furthermore, once a GPU request has been provisioned, users can choose to “early-release” it. This functionality is critical for efficient resource management, as it allows users to promptly deallocate provisioned GPU nodes from their Slice VPC when they are no longer needed. This proactive release frees up valuable resources for other users, enhancing overall cluster efficiency.

### Alternative Methods for GPU Request Creation

In some embodiments, beyond the EGS User portal, GPU requests (GPRs) can be programmatically created through alternative methods. These include leveraging EGS APIs for direct integration with external systems, or by applying GPR custom resource YAML files directly to the KubeApi server. These advanced methods are particularly useful for automated workflows. They can be invoked by Continuous Integration/Continuous Deployment (CI/CD) pipelines, Retrieval-Augmented Generation (RAG) pipelines, external systems/services, or even application services running within the cluster. This flexibility ensures that GPU resource allocation can be seamlessly integrated into complex, automated development and deployment environments.

### Centralized Management of GPU Request Lifecycle: The GPR Manager

In some embodiments, the EGS control plane houses the GPU requests (GPR) manager, a core component responsible for overseeing the entire lifecycle of GPU requests. Upon submission, GPU requests are intelligently inserted into a pending requests queue. The precise position and the estimated wait time for each request are determined by a sophisticated enqueue logic. This logic takes into account a multitude of factors, including:
Inventory Available: The current availability of GPU resources across the cluster.
Allocations: Existing allocations and reservations of GPU resources.
Priority: The designated priority level of the GPU request, allowing critical workloads to be processed sooner.
Fairness: Ensuring equitable access to GPU resources across all users and teams, preventing resource monopolization.
Other Requests in the Queue: The current state and characteristics of other requests already in the queue, influencing the placement of new requests.

### The EGS Queue Manager (QueueMgr): A Core Orchestrator

In some embodiments, a pivotal component within the EGS system is the EGS Queue Manager (QueueMgr). This dedicated component meticulously maintains a queue of pending GPR requests, prioritizing them based on an assigned integer priority number. The QueueMgr exposes a rich and efficient set of APIs, enabling other components within the EGS ecosystem to seamlessly interact with it.

In some embodiments, the GPR manager, working in close conjunction with the QueueMgr, plays a dynamic role in moving GPR requests both into and out of the queue. This continuous management is intrinsically linked to the ongoing management of the GPU resource inventory and its allocation. By orchestrating the flow of requests and intelligently allocating resources, the GPR manager ensures optimal utilization of the valuable GPU infrastructure, supporting a wide array of demanding computational tasks.

AI Workload and GPU Observability within the EGS User Portal

In some embodiments, the EGS User portal provides comprehensive observability into AI workloads and GPU performance, offering users detailed insights into their operations. This robust platform is designed to empower users with the information needed to monitor, optimize, and troubleshoot their AI initiatives effectively.

The portal delivers a detailed view of AI workloads operating within the User workspace (namespaces). This granular visibility allows users to track the status and performance of individual workloads, ensuring they are running as expected. Complementing this, a user-focused dashboard presents key metrics across User Slices, workloads, and GPUs. This centralized dashboard serves as a high-level overview, enabling quick identification of trends and potential issues.

Beyond basic metrics, the portal provides detailed event and notification information for various alerts related to GPUs, workloads, and GPU requests. This proactive alerting system ensures users are immediately aware of any anomalies or critical events, allowing for timely intervention and minimizing disruption to AI operations.

Model Details Page: In-depth Insights into AI Model Performance

In some embodiments, the Model Details page offers a deep dive into individual workload models, providing critical information about their underlying infrastructure and resource consumption. This page displays the specific GPU infrastructure committed to each model, whether it's for large language model (LLM) training, LLM fine-tuning, or other specialized jobs. This transparency allows users to verify that resources are appropriately allocated for their AI tasks. A key feature of the Model Details page is its ability to highlight GPU performance hotspots. It meticulously displays metrics such as high power consumption, high temperature, and average utilization values for each GPU. For training or fine-tuning jobs that leverage a large number of workers and GPUs, this page is invaluable, offering a rapid visual identification of GPUs that are under stress or performing sub-optimally. This immediate feedback enables users to take corrective actions, such as adjusting workload distribution or optimizing model parameters, to enhance overall efficiency and prevent hardware degradation.

### Pods Details Page: Granular GPU Monitoring at the Pod Level

In some embodiments, the Pods Details page provides a more granular view, focusing on individual pods and their associated GPU devices. This page details the specific GPU devices utilized by each pod, offering a clear picture of resource allocation at the pod level. Crucially, a dedicated GPU dashboard link is integrated within the Pods Details page. This link directs users to time-series data specifically related to the GPUs employed by the pods. This feature is particularly beneficial as it enables users to access NVIDIA DCGM (Data Center GPU Manager) metrics for their pods. DCGM provides a wealth of performance data, including detailed information on GPU utilization, memory usage, temperature, power consumption, and error rates. Access to this rich dataset empowers users to conduct in-depth analysis of GPU performance, identify bottlenecks, and fine-tune their AI applications for optimal performance.

### GPU Table: Consolidated View and Hotspot Identification

In some embodiments, the GPU table consolidates information about all GPUs utilized by a specific model (such as an LLM training or fine-tuning job) into a single, easily digestible format. This centralized view simplifies the monitoring of large-scale AI deployments. To facilitate quick identification of potential issues, the table is intelligently sorted to prioritize GPUs with high power consumption or elevated temperatures, displaying them at the top. This sorting mechanism provides an immediate visual indicator of GPU hotspots, allowing users to focus their attention on components that may require immediate action. Furthermore, the GPU table incorporates robust filters and search options, enabling users to narrow down the displayed GPUs based on various criteria. This functionality is essential for managing complex environments with numerous GPUs, allowing users to quickly locate specific devices or groups of devices that are relevant to their investigation or optimization efforts.

### Observability

In some embodiments, the EGS Worker aiOps operator plays a critical role in maintaining the health, performance, and stability of GPU infrastructure across all Slice VPCs. This advanced system is designed for comprehensive monitoring and proactive remediation, ensuring that users can consistently execute their training and tuning jobs with minimal disruption.

### Continuous Monitoring of Key GPU Metrics:

In some embodiments, at its core, the EGS Worker aiOps operator provides ceaseless surveillance of vital GPU metrics. This includes: Power Consumption: Monitoring power draw helps identify inefficiencies, potential hardware issues, or unexpected workloads that could strain the power infrastructure. Temperature: Tracking GPU temperatures is crucial for preventing overheating, which can lead to performance degradation, hardware damage, and system instability. The operator ensures that GPUs operate within safe thermal limits. Utilization Rates: By continuously analyzing GPU utilization, the operator can identify underutilized resources that could be reallocated or overutilized GPUs that might be bottlenecks. This allows for optimal resource allocation and workload balancing.

### Event Generation, Alerting, and Notifications:

In some embodiments, the operator is configured with sophisticated thresholding capabilities. When any of the monitored metrics deviate from their predefined optimal ranges, the system automatically triggers a multi-faceted response. This response includes event generation, where detailed events are logged to provide a historical record of metric violations and system behavior, which is invaluable for post-incident analysis and long-term trend identification. Additionally, immediate alerts are generated to notify operations teams of critical deviations. These alerts are designed to be actionable, providing specific information about the nature of the violation and the affected GPU nodes or Slice VPCs. Finally, depending on the severity and type of violation, notifications are dispatched to relevant stakeholders through various channels (e.g., email, PagerDuty, Slack), ensuring prompt awareness and response.

### Configuration Drift Detection and Remediation:

In some embodiments, beyond real-time metric monitoring, the EGS Worker aiOps operator excels at maintaining the desired state of the GPU infrastructure. It constantly compares the current configuration of Slice VPCs and their associated GPU nodes against a predefined “desired state.” Any discrepancy or “configuration drift” is immediately detected. This could include unauthorized changes, software misconfigurations, or unexpected alterations to system parameters. Upon detecting configuration drift, the operator initiates automated remediation workflows to bring the Slice VPC back into compliance with its desired state. This proactive approach prevents potential performance degradation, security vulnerabilities, or operational inconsistencies that could arise from misconfigurations.

### Proactive GPU Error Detection and Remediation (GPR):

In some embodiments, a key differentiator of the EGS Worker aiOps operator is its ability to proactively identify and address potentially failing GPU nodes. This goes beyond simple threshold violations to analyze subtle signs of impending failure.

First, through GPU Error Monitoring, the system constantly monitors for specific GPU errors, including those reported by hardware sensors or software diagnostics. It also analyzes error trends, looking for patterns or increasing frequencies of minor errors that could indicate a developing problem. Second, by leveraging historical data and sophisticated algorithms, the operator can predict a potentially failing GPU node even before a catastrophic failure occurs. This predictive capability is crucial for minimizing downtime.

When a potentially failing GPU node is identified, the GPR (GPU Proactive Remediation) node-replacement workflow is automatically triggered. This workflow is meticulously designed for minimum disruption, continuous user operations, and automated provisioning. The process is engineered to remove the faulty node and seamlessly integrate a new, healthy node into the Slice VPC with the absolute minimum impact on ongoing operations. Users can continue with their critical training or tuning jobs with virtually no interruption, as the system intelligently migrates workloads or reallocates resources during the node replacement. The new GPU node is automatically provisioned and configured to match the desired state of the Slice VPC, ensuring consistency and immediate readiness for workloads.

In essence, the EGS Worker aiOps operator provides an intelligent, automated, and highly resilient framework for managing GPU resources, guaranteeing optimal performance, high availability, and a seamless experience for users engaged in compute-intensive AI workloads.

### Multi-Cloud, Multi-Cluster Slice VPC: Enhancing Resource Management and Global Accessibility

In some embodiments, the EGS Control Plane is a sophisticated management layer designed to streamline the orchestration and utilization of computing resources across diverse environments. It offers comprehensive workflows that enable the registration of various clusters, whether they reside in public cloud providers (such as AWS, Azure, GCP), at the edge, or within traditional data centers, all under a single project. This capability is foundational to creating a truly unified and globally accessible infrastructure.

One of the most powerful features of the EGS Control Plane is the ability for EGS Administrators to define and deploy “slices” that seamlessly span across multiple registered clusters. A slice represents a logical partitioning of resources, allowing for the creation of a distributed virtual private cloud (VPC) that transcends geographical and infrastructural boundaries. This means that applications and services within a slice can communicate and operate as if they are in a single, contiguous network, regardless of their underlying physical location.

Within these multi-cluster slices, users can leverage “workspaces” (which are typically mapped to namespaces in container orchestration systems like Kubernetes). These workspaces provide a dedicated, isolated environment for teams or applications, offering a clear organizational structure for resource allocation. Crucially, users gain the flexibility to provision resources, including specialized hardware like GPUs, in any of the associated clusters within their slice. This dynamic allocation is driven by specific requirements, such as proximity to data, regulatory compliance, performance needs, or cost optimization. For example, a user might decide to provision GPUs in a cluster located in a specific region to minimize latency for local users, or choose a different cluster based on the availability of a particular GPU model.

Beyond mere provisioning, EGS provides robust GPU resource management capabilities. This includes real-time visibility into GPU utilization across all registered clusters, allowing administrators and users to monitor performance, identify bottlenecks, and make informed decisions about resource scaling and allocation. The platform offers centralized control over GPU quotas, access policies, and scheduling, ensuring optimal utilization and preventing resource contention. This comprehensive management framework not only enhances operational efficiency but also maximizes the return on investment in expensive GPU hardware.

In essence, the Multi-Cloud, Multi-Cluster Slice VPC paradigm offered by EGS empowers organizations to build resilient, globally distributed applications that can dynamically leverage the best available resources, regardless of their physical location. It simplifies complex multi-cloud deployments, accelerates innovation by providing flexible resource access, and offers the granular control necessary to manage high-performance computing workloads effectively.

### Deployment Options

In some embodiments, EGS supports multiple deployment models to accommodate different organizational needs and infrastructure configurations:

### Single Cluster Deployment

In some embodiments, in a single cluster deployment, the EGS control plane and worker components (aiOps Operator) are deployed within the same cluster but in different namespaces. This model is suitable for organizations with a single Kubernetes cluster containing GPU resources, proof of concept implementations, and smaller deployments where all GPU resources are centralized. Key characteristics include simplified installation and management, all components communicating within the same cluster, reduced network complexity, and lower latency for control plane operations.

### Multi-Cluster Deployment

In some embodiments, multi-cluster deployment enables GPU resource management across multiple Kubernetes clusters, supporting both multi-cloud and hybrid scenarios. A separate controller cluster manages multiple worker clusters, which can span different cloud providers (AWS, OCI, Azure). There is a centralized control plane with distributed GPU resources. Support is provided for edge and data center clusters alongside cloud clusters. Slice Workspace can span across one or more clusters. The system includes multi-cluster allocation management and multi-cluster workload placement (GPU workload). Cluster selection for workload (GPU workload) placement is also supported. When capacity in a cluster is not available for a workload, the workload placement allocation algorithm picks a cluster with enough capacity to place the workload, based on GPU availability, cost, and latency.

### Deployment Configurations

In some embodiments, EGS supports various GPU deployment modes within clusters: Bare Metal GPUs provide direct access to physical GPU resources. vGPU/MIG Deployments offer Virtual GPU and Multi-Instance GPU configurations for resource sharing. Time-slicing enables software-based GPU sharing for multiple workloads. Mixed Mode allows for a combination of different GPU modes within the same slice.

### Network Deployment Options

In some embodiments, RDMA/InfiniBand: High-performance networking for GPU interconnect. Standard Ethernet: Traditional networking for less demanding workloads. ROCE (RDMA over ethernet) V1 and V2; Slice Overlay Networks: Virtual networks spanning multiple clusters. Multi-network Configurations: Support for separate data and control plane networks. GPU interconnect: Quantum NvLink, Spectrum/Ethernet, RDMA/IB Network, Blocks.

In some embodiments, a comprehensive system for Elastic GPU Service (EGS) that enables:

1. Dynamic GPU Resource Allocation with Cluster Time-Slicing

Multi-Cluster GPU Federation: Unified management and allocation of GPU resources across multiple Kubernetes clusters, breaking traditional cluster boundaries. Temporal Resource Scheduling: Advanced cluster time-slicing mechanism that enables GPU resources to be dynamically shared across users and workloads based on time windows. Cross-Cluster Resource Mobility: Ability to dynamically slide GPU nodes in and out of slices across cluster boundaries, maximizing resource utilization. Heterogeneous Infrastructure Support: Seamless resource allocation across cloud, edge, and data center deployments with unified control plane.

2. GPU Abstraction Layer with Automated Provisioning

Logical Resource Pools: Hardware-agnostic GPU abstraction that decouples workload requirements from physical infrastructure. Dynamic Node Configuration: Automated setup and configuration of GPU nodes including device plugins, network plugins, operators, and Custom Resources (CRs). Multi-Mode GPU Support: Unified management of GPUs in various deployment modes (bare metal, VM, vGPU, MIG, MIG-vGPU) within the same slice. Zero-Touch Provisioning: Fully automated GPU node preparation and deployment, reducing SRE manual effort by 80%.

3. Intelligent Workload Placement with Predictive Optimization

Multi-Dimensional Scheduling: Advanced placement algorithms considering GPU availability, network topology (RDMA/InfiniBand/NVLink), cost, and performance requirements. Queue-Aware Resource Allocation: Intelligent GPU Provisioning Request (GPR) queue management with wait-time prediction models. Workload-Specific Optimization: Differentiated scheduling strategies for training, fine-tuning, inference, and HPC workloads. Predictive Capacity Planning: ML-driven models for proactive resource provisioning based on historical patterns and trend analysis.

### 4. Reinforcement Learning-Based Resource Management

Adaptive Scaling Intelligence involves RL agents that learn optimal scaling patterns for different workload types and priorities. Multi-Objective Optimization balances utilization, performance, cost, and wait times through sophisticated reward functions. Continuous Learning refers to a self-improving system that adapts to changing workload patterns and infrastructure configurations. Inference-Specific Optimizations include specialized RL models for inference endpoint scaling, in addition to RL to scale independent LLM Prefill and Decode instances scaling.

### 5. Comprehensive Multi-Tenant GPU Workspace Management

Isolated GPU Slices: Secure, multi-tenant workspaces with guaranteed resource boundaries and network isolation. Dynamic Slice Lifecycle: Automated creation, modification, and teardown of GPU slices with resource reclamation. Hierarchical Resource Organization: Support for multiple tenants with multiple teams, each with isolated GPU resources. Network Virtualization: Slice-specific overlay networks with support for high-performance interconnects (RDMA, InfiniBand).

### 6. Advanced Observability and Advisory Intelligence

Unified Dashboards: Comprehensive visibility for both users (developers/data scientists) and administrators with drill-down capabilities. Real-Time GPU Metrics: Monitoring of utilization, temperature, power, memory, errors, and network performance. ML Model Advisory Tool: Intelligent recommendation system for optimal GPU resource selection based on model characteristics. Cost-Performance Optimization: Advisory algorithms that suggest resource configurations balancing cost, availability, and wait times.

### 7. Automated Network and Infrastructure Management

Dynamic RDMA Configuration: Automated setup and teardown of high-performance network connections during provisioning. Rapid Node Reconfiguration: Quick turnaround of GPU nodes between different slices and configuration modes. Self-Healing Infrastructure: Automatic detection and remediation of configuration drifts and hardware failures. Dynamic Pool Management: Automated creation and adjustment of dedicated and shared GPU pools based on demand.

### 8. Enterprise-Grade Deployment Flexibility

Multiple Deployment Models: Support for single cluster/tenant, multi-cluster/tenant, and provider-managed cluster configurations. Hybrid Infrastructure Support: Seamless operation across on-premises, cloud, and edge environments. Provider-Agnostic Design: Works with any Kubernetes distribution and GPU hardware vendor. Scalable Architecture: Supports from small departmental deployments to large-scale enterprise GPU farms.

### 9. Governance of GPU Resources

Manage inventory across one or more data centers, clusters, regions, zones, etc. Track and find GPU resources for workloads in one or more clusters or data centers or regions, etc. Move idle GPUs across one or more clusters-within a data center, zone, on-prem data center, etc. Track inference deployments, fine-tuning and training workflows in a workspaces-use MLFlow or W&B or other tracking tools or custom built tools to track the deployments and compare the runs. IAM (Identity and access management) policy integration for managing account or system GPU resources and tracking the access and providing access control to the GPU resources. Use policies to provide access control to GPU resources. This includes ability to detect any policy violations and integrity of the system. Policy can include-unauthorized access to models or GPUs by a workload. Influence Resource Scheduling From the pool of GPU resources available to an organization, EGS will establish a relationship between users and those GPUs and will control when those resources will be made available to each user. Essentially we will allow the org to choose when to make a (set of) GPU(s) available to a user (and when to remove them).

This comprehensive EGS system represents a paradigm shift from static, cluster-bound GPU management to a dynamic, intelligent, and automated resource orchestration platform that maximizes GPU utilization while minimizing operational overhead and improving time-to-value for AI/ML workloads.

EGS Smart Scaler for LLM and AI/ML workloads Overview

In some embodiments, Smart Scaler is an AI-driven autoscaling solution designed to optimize large language model (LLM) inference workloads and other AI/ML workloads within Kubernetes environments. Leveraging reinforcement learning (RL), it proactively adjusts GPU and CPU resources in real-time, ensuring efficient scaling that aligns with dynamic workload demands.

Such features, alternatives, configurations, etc. in accordance with certain embodiments were described in earlier-mentioned U.S. Application No. 63/670,262 (e.g., see pages 102-114, 171-172, 214-228).

Smart Scaler—RL based auto-scaler use cases:

In some embodiments, LLM inference workloads (LLM models) can use instances auto scaling. This applies to single pod instances, multiple pod instances in a single node, and multiple pod instances across one or more nodes. These instances can be using one or more GPUs in a pod (workload).

For LLM inference workloads (LLM models), prefill and decode instances can be autoscaled. The deployment will involve one or more prefill and one or more decode instances. The Smart Scaler RL based auto-scaler (RL based planner with SLA, SLA planner) will scale ‘m’ prefill instances to ‘n’ decode instances. It will use prefill/decode, KV cache, and prefix metrics, along with LLM/ML framework metrics for training and real-time metrics for scaling.

AI/ML workloads can also benefit from inference auto-scaling, using GPU and workload metrics for RL based prediction.

### Key Features and Benefits:

Enhanced Throughput and Latency Reduction: Smart Scaler has demonstrated significant performance improvements, including up to 3× higher instantaneous throughput and a 75% reduction in inference latency.
Predictive Scaling with RL: Unlike traditional autoscalers that react to metrics like CPU usage, Smart Scaler employs RL to anticipate workload patterns. This predictive approach allows for proactive resource allocation, minimizing cold starts and ensuring consistent performance during traffic surges.
Integration with Kubernetes Ecosystem: Smart Scaler seamlessly integrates with Kubernetes, supporting tools like Horizontal Pod Autoscaler (HPA), Vertical Pod Autoscaler (VPA), and Karpenter. Its agents collect real-time metrics, feeding them into the RL models to make informed scaling decisions.
Cost Optimization: By aligning resource provisioning with actual workload demands, Smart Scaler reduces overprovisioning, leading to cost savings. It supports a pay-per-work-output pricing model, charging based on actual work done (e.g., tokens processed) rather than time-based GPU usage.
Ideal for Dynamic Workloads: Smart Scaler is particularly beneficial for applications with fluctuating traffic patterns, such as LLM inference services, where demand can be unpredictable and bursty.

In summary, Smart Scaler offers a sophisticated, AI-powered approach to autoscaling, enhancing performance and cost-efficiency for LLM inference and other AI/ML workloads in Kubernetes environments.

In some embodiments, EGS Smart Scaler provides predictive auto scaling for LLM inference and AI/ML deployments.
Scale EGS managed Inference Endpoints (IEP) deployments
   LLM inference deployments deployed and managed by EGS
Scale User managed LLM inference deployments in a EGS workspace
Scale AI/ML inference and other type of AI/ML GPU workload deployments
   Smart Scaler system consists of mainly three modules:
1. Pod capacity estimation module
2. RPS prediction module
3. RL inference module

### Resource Optimization

Resource optimization (horizontal pod autoscaling) and LLM model/inference application performance in cloud computing Kubernetes environments.

### Pod Capacity Estimation (PSE)

In some embodiments, Resource Pod capacity estimation of LLM model/inference applications with ML/LLM framework metrics, GPU/CPU and other infra metrics that can fulfill without degrading the application performance (maintaining SLO with latency and error percentage).

The Pods capacity model is an ensemble of ML and statistical models:

In some embodiments, there is Linear Regression, Polynomial Regression, Lasso, Elastic Net, Random Forests, XGBoost, Gradient Boost.

### RPS Predictor

Load/RPS prediction for an LLM model/Inference deployment.

In some embodiments, there is ensemble of models for RPS prediction: Short term forecasting using regression models such as linear, polynomial, XG Boost, Gradient Boost, and Random Forest. Long term forecasting employing LSTM neural network models. Time series based forecasting with ARIMA and Prophet. Event based forecasting.

### RL PPO Inference Module

In some embodiments, this module is responsible for providing scaling recommendations for LLM/Inference application deployments. It uses the checkpoint from the training module.

RL Proximal Policy Optimization (PPO) model ingests pod capacity model outputs, specifically datasets and pod capacity of the LLM/Inference pod (per GPU/memory spec). It also ingests RPS predictions and real-time metrics, including LLM/Token metrics, latency, GPU/CPU/Memory utilization, current pods, and errors.

### Metrics

In some embodiments, the Smart Scaler system utilizes various metrics. These include infrastructure metrics such as GPU/CPU and memory utilization. Application metrics like service/application latency, RPS per service, and errors are also used. Furthermore, LLM/ML framework metrics are crucial. Examples of these are num-requests-running, num-requests-waiting, token metrics, batch metrics, load metrics, TTFT, KV cache metrics, inference metrics, and network metrics. Metrics are also gathered from ML/LLM Frameworks such as NIM, Triton Inference, TRT-LLM, vLLM, vLLM production-stack, Dynamo-ai aggregated/disaggregated prefill and decode stack, AIBrix, and SGlang. Finally, the system incorporates various LLM and other types of model-specific metrics.

### Training Module

In some embodiments, the training module consists of multiple modules that creates the simulator for simulating the application behavior and AI agents for learning to find optimal strategies for resource optimization for an application by considering different types of metrics. The output of the training module is a model checkpoint that is deployed in an LLM/Inference application production environment to autonomously manage the distributed cluster resources used in the application.

### Smart Scaler Predictions

In some embodiments, in benchmarking tests, Smart Scaler demonstrated the ability to scale pods 3× faster or more compared to standard Kubernetes Horizontal Pod Autoscaler (HPA). This improvement is due to the predictive scaling capabilities of the RL model, which proactively provisions capacity ahead of traffic surges.

Additionally, Smart Scaler continuously adapts its recommendations based on the evolving RPS curve, dynamically scaling up or down to maintain optimal throughput and latency. To enable more than 3× instantaneous burst performance for LLM model inference, a significant increase in incoming traffic (load) to the LLM inference service is required, along with sufficient node capacity available in the cluster to support the burst. Additionally, Smart Scaler must be actively monitoring and managing the deployment.

Smart Scaler achieves rapid scaling and burst readiness by leveraging real-time ingestion of critical metrics, including the number of running and waiting requests. DCGM GPU telemetry (e.g., memory, utilization), KV cache utilization, and Kubernetes KSM metrics (e.g., pod CPU, memory). It also incorporates pod capacity awareness, ensuring scaling decisions align with the service's actual resource limits. Furthermore, Smart Scaler utilizes Request Per Second (RPS) Modeling, which encompasses real-time RPS tracking and load prediction, as well as a forecasting ensemble of 7 AI models for both short-term and long-term RPS predictions. Finally, a reinforcement learning (RL) model consumes RPS forecasts and real-time metrics to recommend the optimal number of pods.

In benchmarking tests, Smart Scaler demonstrated the ability to scale pods 3× faster or more compared to standard Kubernetes Horizontal Pod Autoscaler (HPA). This improvement is due to the predictive scaling capabilities of the RL model, which proactively provisions capacity ahead of traffic surges. Additionally, Smart Scaler continuously adapts its recommendations based on the evolving RPS curve, dynamically scaling up or down to maintain optimal throughput and latency.

### Why Smart Scaler Outperforms Traditional Autoscaling

In some embodiments, unlike traditional HPA, which relies on reactive metrics, Smart Scaler incorporates a broader set of infrastructure and model-level signals. This allows it to understand the relationship between system-level metrics and LLM inference performance, enabling smarter and faster decisions under load.

### Pod Capacity Estimation (PSE) Model

### Overview

The Pod Capacity Estimation (PSE) model is an ensemble-based system designed 2 to estimate the request-handling capacity of an LLM inference pod. It leverages a combination of historical telemetry, infrastructure configurations, and workload characteristics to make accurate predictions. This estimation is a critical input for the Smart Scaler RL model, enabling it to scale pods precisely based on expected load.

### Inputs to the PSE Model

The PSE model ingests a variety of signals to estimate pod capacity:

### 1. Historical Metrics

These include infrastructure metrics (CPU, GPU, memory), framework-level and model-level telemetry, and Kubernetes KSM and DCGM metrics.

### 2. Infrastructure Configuration

This encompasses GPU node type and memory size, and MIG instance configuration, if applicable.

### 3. Workload Configuration

This covers LLM framework type (vLLM, TRT-LLM, TGI), decoding strategy (e.g., chunked decoding), and model category (reasoning vs. non-reasoning models).

### 4. Model Configuration

This includes model type and architecture (e.g., LLAMA 3.1 8B), precision (e.g., FP16, INT8), batch size, max sequence length, max tokens, and Tensor Parallelism (TP) values.

### Benchmarking the Pod Capacity (PSE)

In some embodiments, pod capacity benchmarking is essential for initializing Smart Scaler. Here is the step-by-step process:

### Step 1: Model and Framework Selection

First, choose the model, inference framework, and relevant parameters. For example, LLAMA 3.1 8B, vLLM, FP16, with a Batch Size of 256, and a Max Sequence Length of 8192. Set framework-specific parameters as needed.

### Step 2: Estimate Memory and KV Cache Requirements

Next, use memory estimation tools or spreadsheets to calculate the model memory footprint, the remaining GPU memory for key-value (KV) cache, the maximum concurrent request support, and any additional memory for reasoning models, which typically have a higher KV cache demand.

### Step 3: Select GPU Configuration

Then, select your GPU configuration. Examples include B200 (180 GB), B200 MIG (44 GB per instance), H100 (80 GB) or H100 MIG (40 GB), A100 (80 GB), or A10 (25 GB).

### Step 4: Choose Metrics to Ingest

Based on the framework, choose the metrics to ingest. These can include TRT-LLM, vLLM, or TGI backend metrics; DCGM GPU metrics (e.g., memory usage, SM utilization); Kubernetes KSM metrics; and CPU, memory, and network usage.

### Step 5: Load Generation and Data Collection

Use Locust to simulate traffic by defining concurrent users per instance and the number of Locust instances. Capture real-time data during the load in Prometheus.

### Step 6: Run PSE Model Job

Finally, after collecting sufficient data (e.g., 2+ load cycles), run the PSE model to analyze historical and real-time metrics. The model performs predictions using a mix of statistical and machine learning models.

### PSE Model Output Evaluation

### Step 1: Data Integrity Checks

Before any analysis or model training can commence, a rigorous data integrity check is paramount. This initial phase ensures that the foundation of our predictive modeling is sound.

Validate data quality and completeness: This involves a comprehensive assessment of the raw data collected from various sources. We verify that all necessary data points are present and free from corruption, missing values, or inconsistencies. Techniques include checking for data type mismatches, out-of-range values, and duplicate entries. We also ensure that the data accurately reflects the system's operational parameters and historical performance.

Extract relevant statistical indicators: From the validated dataset, we derive key statistical indicators that provide an initial understanding of the system's behavior. This includes metrics such as average resource utilization, peak loads, latency distributions, error rates, and throughput. These indicators serve as a baseline for further analysis and help identify any immediate anomalies or trends.

### Step 2: Statistical Analysis

With a clean and complete dataset, we proceed to a deeper statistical analysis to uncover underlying patterns and relationships.

Compute average and minimum pod capacity support: This involves calculating the typical and lowest observed resource capacity that individual pods (or logical units of deployment) can sustain. This helps in understanding the baseline performance and potential bottlenecks within the system. For instance, we might analyze the average CPU and memory utilization per pod, as well as the minimum guaranteed resources.
Identify outliers and performance thresholds: Through various statistical methods, we identify data points that deviate significantly from the norm (outliers) and establish critical performance thresholds. Outliers could indicate anomalous system behavior, misconfigurations, or unusual events. Performance thresholds, on the other hand, define the acceptable operating limits for key metrics, helping to trigger alerts or flags when exceeded. This might involve using techniques like z-scores, IQR, or visual inspection of distribution plots.

### Step 3: ML and Model Validation

This crucial step involves the application and rigorous evaluation of machine learning models to predict system behavior.

Evaluate ML models' prediction scores: A diverse set of machine learning models (e.g., regression, time-series, classification) are trained on the prepared data. Their predictive performance is then evaluated using appropriate metrics such as R-squared, Mean Absolute Error (MAE), Root Mean Squared Error (RMSE) for regression, or precision, recall, and F1-score for classification tasks. This evaluation assesses how accurately each model forecasts future system states or resource requirements.

Select top-performing models: Based on the evaluation scores and domain expertise, the models that demonstrate the highest predictive accuracy and robustness are selected for further consideration. This often involves a comparative analysis of multiple models, considering their strengths and weaknesses in different scenarios.

### Step 4: Consensus Evaluation

To enhance the reliability and confidence in the predictions, we employ ensemble techniques that combine the strengths of multiple models.

Apply ensemble voting: majority wins, ties handled via heuristics: For scenarios where multiple models provide predictions, an ensemble voting mechanism is used. In a “majority wins” approach, the prediction supported by the largest number of selected models is chosen. For instances where there's a tie, predefined heuristics (e.g., prioritizing models with higher individual confidence scores, or those historically performing better in similar edge cases) are applied to break the deadlock and arrive at a definitive prediction.

Statistical consensus used for model agreement: Beyond simple voting, statistical consensus methods are employed to gauge the level of agreement among the top-performing models. This might involve calculating the variance or standard deviation of their predictions. A high degree of consensus among models increases confidence in the final output, while significant disagreement might flag areas requiring further investigation or human review.

### Step 5: Heuristic Review

Even with sophisticated models and ensemble techniques, human oversight remains vital, especially for complex or ambiguous situations.

Human-in-the-loop validation of borderline cases: This step incorporates human intelligence to review and validate predictions, particularly for “borderline” cases where models might exhibit lower confidence, or where the predicted outcome is highly sensitive. Experienced engineers or subject matter experts manually examine these cases, leveraging their intuition and deeper understanding of the system to confirm or adjust the model's output. This crucial step acts as a safeguard against potential model errors or biases.

### Step 6: Final Selection

The culmination of the preceding steps leads to the final selection of the most accurate and reliable prediction.

Weighted scoring if multiple models are selected: If the ensemble process results in multiple highly performing models contributing to the final prediction, a weighted scoring system might be implemented. This assigns different weights to each model's contribution based on their historical accuracy, robustness, or relevance to the specific prediction scenario. This allows for a more nuanced and informed final decision.
Prioritize based on predictive performance and reliability: The ultimate prioritization of the final prediction is based on a comprehensive assessment of its predictive performance (accuracy, precision, recall) and its overall reliability (consistency, robustness to varying conditions). The prediction that best balances these two factors is ultimately chosen as the definitive output.

### Step 7: Guardrails

To ensure the practical applicability and safety of the predictions, critical “guardrails” are established.

Ensure final predictions align with observed system behavior: This crucial guardrail mandates that the final predictions are logically consistent with the actual, observed behavior of the system. Any predictions that significantly deviate from historical or real-time system trends are flagged for further investigation. This prevents the system from acting on erroneous or unrealistic forecasts.
Prevent overestimation or underestimation: Specific guardrails are implemented to prevent the system from making predictions that are either overly optimistic (overestimation) or overly pessimistic (underestimation). For example, if the system is predicting future resource requirements, overestimation could lead to wasteful resource allocation, while underestimation could result in performance degradation or outages. These guardrails ensure that predictions remain within sensible operational boundaries.

### Automated PSE Updates

The PSE (Performance Scaling Engine) model is not a static entity; it is designed to be dynamic and continuously improve through automated retraining and updates. This ensures its predictions remain relevant and accurate in an evolving system environment.

The PSE model is retrained and updated periodically to reflect:

Changes in model configurations: As new research emerges, or as the understanding of system dynamics deepens, the underlying machine learning model configurations (e.g., hyper-parameters, algorithms) may be optimized. Automated updates ensure that the PSE model incorporates these improved configurations, leading to more accurate and efficient predictions.
Shifts in traffic patterns: User behavior and application workloads are rarely static. Significant shifts in traffic patterns (e.g., seasonal spikes, new application launches, or changes in user demographics) directly impact system performance. The automated retraining mechanism ensures the PSE model learns from these new patterns, adapting its predictions to reflect the current and anticipated demands.
Infrastructure updates (e.g., new GPU types, MIG configurations): The underlying hardware infrastructure is subject to frequent updates and changes, such as the introduction of newer GPU types, different memory configurations, or changes in Multi-Instance GPU (MIG) allocations. These infrastructure changes directly affect the system's capacity and performance characteristics. Automated PSE updates ensure that the model is continuously retrained with data reflecting these latest infrastructure configurations, allowing it to accurately predict performance on the updated hardware. This proactive approach helps in optimizing resource utilization and performance for the evolving infrastructure.

### Auction Based Allocation

In accordance with certain embodiments and views, one of the issues with GPU allocation and scheduling in machine learning workloads, is the challenge of resource sharing in GPU clusters where long-running applications can monopolize resources and impose significant waiting times on other users.

**The Core Problem**: ML training workloads present unique scheduling challenges compared to traditional computing tasks. They are typically long-running jobs that require gang-scheduling (all tasks must run simultaneously) and are highly sensitive to placement decisions due to inter-task communication requirements. When tasks are placed on the same machine or rack, they benefit from faster communication and significant speedups. Additionally, ML applications are heterogeneous—while about 10% consist of single jobs, approximately 90% involve hyperparameter exploration with up to 100 jobs, creating complex resource allocation scenarios.

**The Effective Solution**: The document proposes a two-level scheduling architecture using an auction-based mechanism. ML jobs bid on available GPU resources offered by a central arbiter (the cloud provider). The key innovation is the use of a “finish-time fairness” metric, defined as the ratio of an application's completion time in a shared cluster (T_sh) to its completion time if it had exclusive access to its proportional share of resources (T_id). The scheduler aims to minimize the maximum finish-time fairness across all applications while maintaining efficient GPU utilization.

**Key Principles and Implementation**: The framework is built on several fairness principles including Pareto Efficiency (no user can be made better off without making another worse off), Envy-Freedom (each user views their allocation as at least as good as others), and Sharing Incentive (users should perform at least as well as having a private cluster of size C/N, where C is total GPUs and N is number of users). To prevent gaming of the system where applications might misreport their fairness metrics to gain more resources, the solution employs auction mechanisms that incentivize truthful reporting. The scheduler trades short-term fairness for efficiency but ensures long-term finish-time fairness through its allocation decisions.

Such features, alternatives, configurations, etc. in accordance with certain embodiments were described in earlier-mentioned U.S. Application No. 63/670,262 (e.g., see pages 156-167).

GPR Advisory Tool with Prediction

In some embodiments, the EGS GPU Provisioning Request (GPR) Advisory Tool is a comprehensive platform designed to help users such as data scientists, AI/ML developers, and SREs efficiently plan and resource their GPU-intensive workloads. The tool provides a user-friendly interface (UI, APIs, or YAML-based) that enables users to explore various LLM and CNN models along with their associated parameters to determine the optimal GPU resources needed for different types of jobs, including training, fine-tuning, inference, and HPC workloads.

In some embodiments, the platform supports an extensive range of LLM models spanning from small to large language models, including popular series like GPT (2, 3.x, 4.x), Llama (2, 3), BERT, Megatron, Claude, and models from Hugging Face and Meta. Users can configure numerous tuning parameters such as sequence length, model size, batch size, epochs, and various parallel processing settings, while working with diverse training frameworks including PyTorch DDP/FSDP, TensorFlow, KubeFlow, Kubernetes, and specialized frameworks like Nvidia NeMO. The tool also accommodates different datasets, tokenizers, and RAG workflows to provide comprehensive job planning capabilities.

In some embodiments, the advisory tool's core value lies in its ability to provide accurate resource estimates and planning insights through EGS inference services. Users receive detailed projections including wait times for different GPU resources, estimated job duration (such as Llama3 fine-tuning timeframes), comprehensive cost breakdowns including GPU costs per hour, required GPU memory, optimal GPU types (A100, H100, etc.), and the number of GPU nodes needed. This intelligent estimation system enables users to make informed decisions about resource allocation, timing, and budgeting for their machine learning and AI workloads.

### Hyperparameter/GPU Prediction

In some embodiments, predicting the number of GPUs required for training a deep learning model based solely on the hyperparameters is a complex task. The number of GPUs needed depends on various factors beyond just the hyperparameters and includes data set, model size, etc.

Such features, alternatives, configurations, etc. in accordance with certain embodiments were described in earlier-mentioned U.S. Application No. 63/670,262 (e.g., see pages 4, 29, 31-32, 189-196).

As described above, an improved technique involves establishing a pool of computing resources and then allocating computing resources from the pool to workspaces identified by GPU provisioning requests (GPRs) based on a set of GPR prioritization policies (e.g., a max-min fairness policy, an assigned priority policy, a greedy policy, a first-in-first-out policy, combinations thereof, etc.). Such techniques enable effective and efficient allocation of computing resources to workspaces, preemptions, optimizations, combinations thereof, and so on. Additionally, such techniques enable the pool of computing resources to be formed from one or more clusters of GPU nodes (e.g., each GPU node including CPU resources, GPU resources, memory, etc.) in which clusters may be co-located and/or separated by large distances. Accordingly, such techniques provide the ability to provision workspaces with computing resources efficiently, to minimize idle time, to scale as needed, and so on.

One embodiment is directed to a method of managing computing resources on a container orchestration platform which includes:
(A) establishing a pool of computing resources on the container orchestration platform;
(B) after the pool of computing resources is established, receiving graphics processing unit (GPU) provisioning requests (GPRs) which identify workspaces; and
(C) allocating computing resources from the pool to the workspaces identified by the GPRs based on a set of GPR prioritization policies.

Another embodiment is directed to computing equipment which includes memory and control circuitry coupled to the memory. The memory stores instructions which, when carried out by the control circuitry, cause the control circuitry to perform a method of:
(A) establishing a pool of computing resources on a container orchestration platform;
(B) after the pool of computing resources is established, receiving graphics processing unit (GPU) provisioning requests (GPRs) which identify workspaces; and
(C) allocating computing resources from the pool to the workspaces identified by the GPRs based on a set of GPR prioritization policies.

Yet another embodiment is directed to a computer program product having a non-transitory computer readable medium which stores a set of instructions to manage computing resources on a container orchestration platform. The set of instructions, when carried out by computerized circuitry, causes the computerized circuitry to perform a method of:
(A) establishing a pool of computing resources on the container orchestration platform;
(B) after the pool of computing resources is established, receiving graphics processing unit (GPU) provisioning requests (GPRs) which identify workspaces; and
(C) allocating computing resources from the pool to the workspaces identified by the GPRs based on a set of GPR prioritization policies.

In some arrangements, the set of GPR prioritization policies includes a max-min fairness policy. Additionally, a first workspace identified by a first GPR is currently allocated with more computing resources than a second workspace identified by a second GPR. Furthermore, allocating the computing resources includes provisioning GPU resources from the pool to the second workspace ahead of the first workspace in accordance with the max-min fairness policy.

In some arrangements, provisioning GPU resources from the pool to the second workspace ahead of the first workspace includes:
(i) generating a first fair share baseline for the first workspace and a second fair share baseline for the second workspace, the first fair share baseline indicating a first target amount of computing resources to allocate to the first workspace, and the second fair share baseline indicating a second target amount of computing resources to allocate to the second workspace;
(ii) generating a first difference between the first fair share baseline and a current amount of computing resources allocated to the first workspace;
(iii) generating a second difference between the second fair share baseline and a current amount of computing resources allocated to the second workspace, the second difference being larger than the first difference; and
(iv) iteratively allocating GPU resources from the pool to the first and second workspaces until the first and second workspaces reach the first and second fair share baselines respectively, or the GPU resources from the pool are exhausted.

In some arrangements, the set of GPR prioritization policies includes an assigned priority policy. Additionally, a first workspace identified by a first GPR is assigned a first priority and a second workspace identified by a second GPR is assigned a second priority, the second priority being higher than the first priority. Furthermore, allocating the computing resources includes provisioning GPU resources from the pool to the second workspace ahead of the first workspace in accordance with the assigned priority policy.

In some arrangements, the method further includes:
(i) after GPU resources are provisioned from the pool to the second workspace ahead of the first workspace, receiving a real-time adjustment which re-assigns the first GPR from the first priority to a third priority which is higher than the second priority; and
(ii) in response to the first GPR being re-assigned to the third priority, provisioning GPU resources from the pool to the first workspace ahead of the second workspace in accordance with the assigned priority policy.

In some arrangements, allocating the computing resources includes provisioning GPU resources from the pool to the workspaces identified by the GPRs based on, as the set of GPR prioritization policies, at least one policy from a group consisting of a max-min fairness policy, an assigned priority policy, a greedy policy, and a first-in-first-out (FIFO) policy.

In some arrangements, the at least one policy includes the max-min fairness policy.

In some arrangements, the method further includes:
(i) reclaiming first GPU resources from a first workspace having computing resources that are underutilized in accordance with a set of predefined utilization criteria, and
(ii) after the first GPU resources have been reclaimed, allocating second GPU resources to a second workspace, the second GPU resources including at least some of the first GPU resources.

In some arrangements, reclaiming the first GPU resources from the first workspace includes deprovisioning the first GPU resources from the first workspace in response to, as one of the set of predefined utilization criteria, the first GPU resources remaining idle for a predefined amount of time.

In some arrangements, the method further includes performing a deprovisioning operation which provides early-release of computing resources from a workspace to the pool or eviction of a workspace in response to one of (i) introduction of a higher priority workspace, (ii) remediation caused by a GPU node failure, or (iii) resource deallocation to accommodate a spot instance allocation request.

In some arrangements, a queue manager circuit is constructed and arranged to maintain a set of pending GPR queues within the container orchestration platform. Additionally, the GPR further identify priorities. Furthermore, the method further includes organizing the GPRs within the set of pending GPR queues based on the priorities identified by the GPRs.

In some arrangements, allocating the computing resources includes processing GPRs from the set of pending GPR queues based on the priorities identified by the GPRs to service GPRs identifying higher priorities ahead of GPRs identifying lower priorities.

In some arrangements, establishing the pool of computing resources on the container orchestration platform includes registering at least one cluster of GPU nodes with a controller circuit of the container orchestration platform.

In some arrangements, registering the at least one cluster of GPU nodes includes adding first GPU resources from a first cluster of first GPU nodes to the pool of GPU resources, and adding second GPU resources from a second cluster of second GPU nodes to the pool of GPU resources to enable one or more workspaces to span across multiple clusters.

In some arrangements, the method further includes deploying inference endpoints among the computing resources allocated to the workspaces to perform a set of workloads, the computing resources spanning multiple clusters.

In some arrangements, the method further includes providing a container orchestration platform interface to a set of client devices to enable receipt of the GPRs through the container orchestration platform interface.

In some arrangements, the method further includes provisioning the computing resources to the workspaces based on GPR attributes including GPU type, memory, number of GPUs, duration and priority specified by the GPRs.

While various embodiments of the present disclosure have been particularly shown and described, it will be understood by those skilled in the art that various changes in form and details may be made therein without departing from the spirit and scope of the present disclosure as defined by the appended claims.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

What is claimed is:

1. A method of managing computing resources on a container orchestration platform, the method comprising:
establishing a pool of computing resources on the container orchestration platform;
after the pool of computing resources is established, receiving graphics processing unit (GPU) provisioning requests (GPRs) which identify workspaces; and
allocating computing resources from the pool to the workspaces identified by the GPRs based on a set of GPR prioritization policies.

2. The method of claim 1, wherein the set of GPR prioritization policies includes a max-min fairness policy;
wherein a first workspace identified by a first GPR is currently allocated with more computing resources than a second workspace identified by a second GPR; and
wherein allocating the computing resources includes:
provisioning GPU resources from the pool to the second workspace ahead of the first workspace in accordance with the max-min fairness policy.

3. The method of claim 2, wherein provisioning GPU resources from the pool to the second workspace ahead of the first workspace includes:
generating a first fair share baseline for the first workspace and a second fair share baseline for the second workspace, the first fair share baseline indicating a first target amount of computing resources to allocate to the first workspace, and the second fair share baseline indicating a second target amount of computing resources to allocate to the second workspace;
generating a first difference between the first fair share baseline and a current amount of computing resources allocated to the first workspace;
generating a second difference between the second fair share baseline and a current amount of computing resources allocated to the second workspace, the second difference being larger than the first difference; and
iteratively allocating GPU resources from the pool to the first and second workspaces until the first and second workspaces reach the first and second fair share baselines respectively, or the GPU resources from the pool are exhausted.

4. The method of claim 1, wherein the set of GPR prioritization policies includes an assigned priority policy;
wherein a first workspace identified by a first GPR is assigned a first priority and a second workspace identified by a second GPR is assigned a second priority, the second priority being higher than the first priority; and
wherein allocating the computing resources includes:
provisioning GPU resources from the pool to the second workspace ahead of the first workspace in accordance with the assigned priority policy.

5. The method of claim 4, further comprising:
after GPU resources are provisioned from the pool to the second workspace ahead of the first workspace, receiving a real-time adjustment which re-assigns the first GPR from the first priority to a third priority which is higher than the second priority; and
in response to the first GPR being re-assigned to the third priority, provisioning GPU resources from the pool to the first workspace ahead of the second workspace in accordance with the assigned priority policy.

6. The method of claim 1, wherein allocating the computing resources includes:
provisioning GPU resources from the pool to the workspaces identified by the GPRs based on, as the set of GPR prioritization policies, at least one policy from a group consisting of a max-min fairness policy, an assigned priority policy, a greedy policy, and a first-in-first-out (FIFO) policy.

7. The method of claim 6, wherein the at least one policy includes the max-min fairness policy.

8. The method of claim 1, further comprising:
reclaiming first GPU resources from a first workspace having computing resources that are underutilized in accordance with a set of predefined utilization criteria, and
after the first GPU resources have been reclaimed, allocating second GPU resources to a second workspace, the second GPU resources including at least some of the first GPU resources.

9. The method of claim 8, wherein reclaiming the first GPU resources from the first workspace includes:
deprovisioning the first GPU resources from the first workspace in response to, as one of the set of predefined utilization criteria, the first GPU resources remaining idle for a predefined amount of time.

10. The method of claim 1, further comprising:
performing a deprovisioning operation which provides early-release of computing resources from a workspace to the pool or eviction of a workspace in response to one of (i) introduction of a higher priority workspace, (ii) remediation caused by a GPU node failure, or (iii) resource deallocation to accommodate a spot instance allocation request.

11. The method of claim 1, wherein a queue manager circuit is constructed and
arranged to maintain a set of pending GPR queues within the container orchestration platform;
wherein the GPR further identify priorities; and
wherein the method further comprises:
organizing the GPRs within the set of pending GPR queues based on the priorities identified by the GPRs.

12. The method of claim 11, wherein allocating the computing resources includes:
processing GPRs from the set of pending GPR queues based on the priorities identified by the GPRs to service GPRs identifying higher priorities ahead of GPRs identifying lower priorities.

13. The method of claim 1, wherein establishing the pool of computing resources on the container orchestration platform includes:
registering at least one cluster of GPU nodes with a controller circuit of the container orchestration platform.

14. The method of claim 13, wherein registering the at least one cluster of GPU nodes includes:
adding first GPU resources from a first cluster of first GPU nodes to the pool of GPU resources, and adding second GPU resources from a second cluster of second GPU nodes to the pool of GPU resources to enable one or more workspaces to span across multiple clusters.

15. The method of claim 1, further comprising:
deploying inference endpoints among the computing resources allocated to the workspaces to perform a set of workloads, the computing resources spanning multiple clusters.

16. The method of claim 1, further comprising:
providing a container orchestration platform interface to a set of client devices to enable receipt of the GPRs through the container orchestration platform interface.

17. The method of claim 1, wherein allocating the computing resources includes:
provisioning the computing resources to the workspaces based on GPR attributes including GPU type, memory, number of GPUs, duration and priority specified by the GPRs.

18. Computing equipment, comprising:
memory; and
control circuitry coupled to the memory, the memory storing instructions which, when carried out by the control circuitry, cause the control circuitry to perform a method of:
establishing a pool of computing resources on a container orchestration platform,
after the pool of computing resources is established, receiving graphics processing unit (GPU) provisioning requests (GPRs) which identify workspaces, and
allocating computing resources from the pool to the workspaces identified by the GPRs based on a set of GPR prioritization policies.

19. A computer program product having a non-transitory computer readable medium which stores a set of instructions to manage computing resources on a container orchestration platform; the set of instructions, when carried out by computerized circuitry, causing the computerized circuitry to perform a method of:
establishing a pool of computing resources on the container orchestration platform;
after the pool of computing resources is established, receiving graphics processing unit (GPU) provisioning requests (GPRs) which identify workspaces; and
allocating computing resources from the pool to the workspaces identified by the GPRs based on a set of GPR prioritization policies.
